(19) United States
(12) Patent Application Publication
(10) Pub. No.: US 2024/0422299 A1
(43) Pub. Date: Dec. 19, 2024

(54) CONTROL DEVICE, CONTROL METHOD, AND CONTROL PROGRAM

(71) Applicant: FUJIFILM Corporation, Tokyo (JP)

(72) Inventor: Kazuyuki ITAGAKI, Saitama-shi (JP)

(73) Assignee: FUJIFILM Corporation, Tokyo (JP)

(21) Appl. No.: 18/816,244

(22) Filed: Aug. 27, 2024

Related U.S. Application Data
(63) Continuation of application No. PCT/JP2023/004220, filed on Feb. 8, 2023.

(30) Foreign Application Priority Data
Feb. 28, 2022 (JP) 2022-030305

(51) Int. Cl. H04N 9/31

(52) U.S. Cl. CPC H04N 9/3188

(57) ABSTRACT

A control device includes a processor, and the processor is configured to: determine, based on imaging data of a projection image of a first image projected by a projection apparatus, continuity of the projection image of the first image; perform first control of moving a boundary, in a first direction, of a projection range of the projection apparatus to the first direction at least until the processor determines that the continuity is not present; and perform second control of moving a boundary, in the first direction, of a projection range of the first image to a second direction opposite to the first direction via image processing at least until the processor determines that the continuity is present, after the first control.

### CROSS REFERENCE TO RELATED APPLICATION

This is a continuation of International Application No. PCT/JP2023/004220 filed on Feb. 8, 2023, and claims priority from Japanese Patent Application No. 2022-030305 filed on Feb. 28, 2022, the entire disclosures of which are incorporated herein by reference.

### BACKGROUND OF THE INVENTION

### 1. Field of the Invention

The present invention relates to a control device, a control method, and a computer readable medium storing a control program.

### 2. Description of the Related Art

JP2020-136909A discloses that, in a case of adjusting a position of a projection image in lens shifting, a projection image including a test pattern is projected on a projection surface, the projection image is moved in a first direction, the projection image is captured, a change in the test pattern included in the captured projection image is detected, and it is determined that the projection image has reached an end part of the projection surface in a case where the change in the test pattern is detected.

JP2013-509767A discloses that, in a case of generating a projection image after calibration on a projected surface, a calibration structure, in which a first side portion and a second side portion extending parallel to the first side portion are included and a height in a direction of the first side portion or the second side portion is constant, is disposed following a spatial spread of the projected surface.

### SUMMARY OF THE INVENTION

One embodiment according to the technology of the present disclosure provides a control device, a control method, and a computer readable medium storing a control program with which it is possible to accurately adjust a projection position.

A control device according to an aspect of the present invention is a control device comprising a processor, in which the processor is configured to: determine, based on imaging data of a projection image of a first image projected by a projection apparatus, continuity of the projection image of the first image; perform first control of moving a boundary of a projection range of the projection apparatus in a first direction to the first direction at least until it is determined that the continuity is not present; and perform second control of moving a boundary of a projection range of the first image in the first direction to a second direction opposite to the first direction via image processing at least until it is determined that the continuity is present, after the first control.

A control device according to an aspect of the present invention is a control device comprising a processor, in which the processor is configured to: perform, based on imaging data of a projection image of a plurality of marker images projected by a projection apparatus and two-dimensionally arranged, detection of the plurality of marker images; perform first control of moving a boundary of a projection range of the projection apparatus in a first direction to the first direction at least until some of the plurality of marker images are not detected; and perform second control of moving a projection range of the plurality of marker images to a second direction opposite to the first direction via image processing at least until the plurality of marker images are detected, after the first control.

A control method according to an aspect of the present invention is a control method executed by a processor included in a control device, the control method comprising: determining, based on imaging data of a projection image of a first image projected by a projection apparatus, continuity of the projection image of the first image; performing first control of moving a boundary of a projection range of the projection apparatus in a first direction to the first direction at least until it is determined that the continuity is not present; and performing second control of moving a projection range of the first image to a second direction opposite to the first direction via image processing at least until it is determined that the continuity is present, after the first control.

A control method according to an aspect of the present invention is a control method executed by a processor included in a control device, the control method comprising: performing, based on imaging data of a projection image of a plurality of marker images projected by a projection apparatus and two-dimensionally arranged, detection of the plurality of marker images; performing first control of moving a boundary of a projection range of the projection apparatus in a first direction to the first direction at least until some of the plurality of marker images are not detected; and performing second control of moving a projection range of the plurality of marker images to a second direction opposite to the first direction via image processing at least until the plurality of marker images are detected, after the first control.

A control program stored in a computer readable medium according to an aspect of the present invention is a control program for causing a processor included in a control device to execute a process comprising: determining, based on imaging data of a projection image of a first image projected by a projection apparatus, continuity of the projection image of the first image; performing first control of moving a boundary of a projection range of the projection apparatus in a first direction to the first direction at least until it is determined that the continuity is not present; and performing second control of moving a projection range of the first image to a second direction opposite to the first direction via image processing at least until it is determined that the continuity is present, after the first control.

A control program stored in a computer readable medium according to an aspect of the present invention is a control program for causing a processor included in a control device to execute a process comprising: performing, based on imaging data of a projection image of a plurality of marker images projected by a projection apparatus and two-dimensionally arranged, detection of the plurality of marker images; performing first control of moving a boundary of a projection range of the projection apparatus in a first direction to the first direction at least until some of the plurality of marker images are not detected; and performing second control of moving a projection range of the plurality of marker images to a second direction opposite to the first direction via image processing at least until the plurality of marker images are detected, after the first control.

According to the present invention, it is possible to provide a control device, a control method, and a computer readable medium storing a control program with which it is possible to accurately adjust a projection position.

### BRIEF DESCRIPTION OF THE DRAWINGS

FIG. 1 is a diagram showing an example of a projection system 100 of an embodiment.

FIG. 2 is a diagram showing an example of a projection apparatus 10.

FIG. 3 is a schematic diagram showing an example of an internal configuration of a projection portion 1.

FIG. 4 is a schematic diagram showing an exterior configuration of a projection apparatus 10.

FIG. 5 is a schematic cross-sectional view of an optical unit 106 of the projection apparatus 10 shown in FIG. 4.

FIG. 6 is a diagram showing an example of a hardware configuration of a computer 50.

FIG. 7 is a flowchart showing an example of processing performed by the computer 50.

FIG. 8 is a diagram showing an example of a change in a projection state of the projection apparatus 10 due to the processing shown in FIG. 7 (part 1).

FIG. 9 is a diagram showing an example of the change in the projection state of the projection apparatus 10 due to the processing shown in FIG. 7 (part 2).

FIG. 10 is a diagram showing an example of the change in the projection state of the projection apparatus 10 due to the processing shown in FIG. 7 (part 3).

FIG. 11 is a diagram showing an example of the change in the projection state of the projection apparatus 10 due to the processing shown in FIG. 7 (part 4).

FIG. 12 is a diagram showing an example of projection of a content image onto a content projection range set by the processing shown in FIG. 7.

FIG. 13 is a flowchart showing another example of content projection range specifying processing 72.

FIG. 14 is a diagram showing an example of a change in the projection state of the projection apparatus 10 due to the processing shown in FIG. 13 (part 1).

FIG. 15 is a diagram showing an example of the change in the projection state of the projection apparatus 10 due to the processing shown in FIG. 13 (part 2).

FIG. 16 is a diagram showing an example of the change in the projection state of the projection apparatus 10 due to the processing shown in FIG. 13 (part 3).

FIG. 17 is a diagram showing an example of the change in the projection state of the projection apparatus 10 due to the processing shown in FIG. 13 (part 4).

FIG. 18 is a diagram showing an example of the change in the projection state of the projection apparatus 10 due to the processing shown in FIG. 13 (part 5).

FIG. 19 is a diagram showing an example of projection control in a case where a S marker 130S cannot be detected in the processing of FIG. 13 (part 1).

FIG. 20 is a diagram showing an example of the projection control in a case where the S marker 130S cannot be detected in the processing of FIG. 13 (part 2).

FIG. 21 is a diagram showing an example of the projection control in a case where the S marker 130S cannot be detected in the processing of FIG. 13 (part 3).

FIG. 22 is a diagram showing an example of a state in which projectable range specifying processing 71 is performed in a state in which a projectable range 11 is inclined.

FIG. 23 is a diagram showing another example of the state in which the projectable range specifying processing 71 is performed in the state in which the projectable range 11 is inclined.

FIG. 24 is a diagram showing a specific example of determination of whether or not a plurality of marker projection images are present on the same plane (part 1).

FIG. 25 is a diagram showing a specific example of the determination of whether or not the plurality of marker projection images are present on the same plane (part 2).

FIG. 26 is a diagram showing an example of setting of a content projection range with respect to an auxiliary line (part 1).

FIG. 27 is a diagram showing an example of setting of the content projection range with respect to the auxiliary line (part 2).

FIG. 28 is a diagram showing an example of setting of the content projection range with respect to the auxiliary line (part 3).

FIG. 29 is a diagram showing an example of setting of the content projection range with respect to the auxiliary line (part 4).

FIG. 30 is a schematic diagram showing another exterior configuration of the projection apparatus 10.

FIG. 31 is a schematic cross-sectional view of the optical unit 106 of the projection apparatus 10 shown in FIG. 30.

### DESCRIPTION OF THE PREFERRED EMBODIMENTS

Hereinafter, an example of an embodiment of the present invention will be described with reference to the drawings.

### Embodiment

### <Projection System 100 of Embodiment>

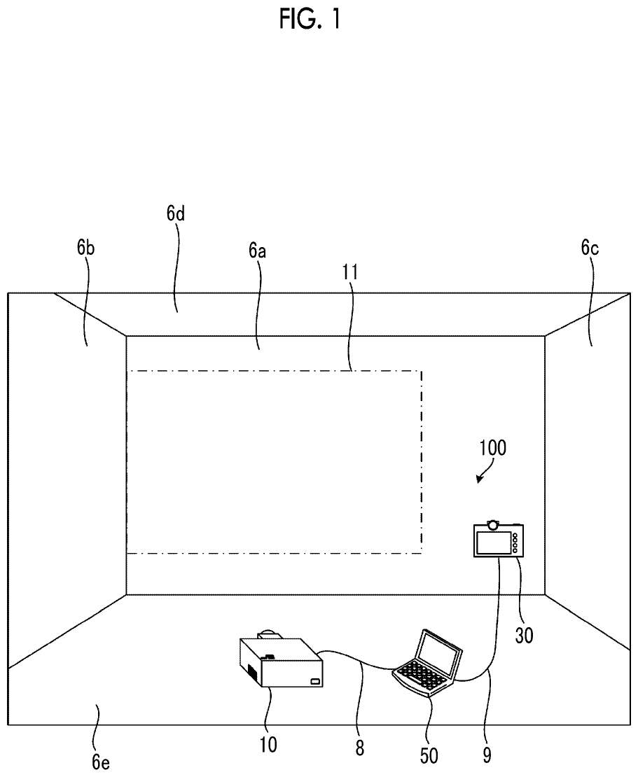

FIG. 1 is a diagram showing an example of a projection system 100 of the embodiment. As shown in FIG. 1, the projection system 100 includes a projection apparatus 10, a computer 50, and an imaging device 30. The computer 50 is an example of a control device according to the embodiment of the present invention.

The computer 50 can communicate with the projection apparatus 10 and the imaging device 30. In the example shown in FIG. 1, the computer 50 is connected to the projection apparatus 10 via a communication cable 8 and can communicate with the projection apparatus 10. In addition, the computer 50 is connected to the imaging device 30 via a communication cable 9 and can communicate with the imaging device 30.

The projection apparatus 10 is a projection apparatus that can perform projection onto a projection target object. The imaging device 30 is an imaging device that can capture an image projected onto the projection target object by the projection apparatus 10. In the example of FIG. 1, the projection system 100 is installed indoors, and an indoor wall 6a is the projection target object. In addition, the projection system 100 controls the projection apparatus 10 such that the projection apparatus 10 projects a content image onto the wall 6a and an end (for example, a left end) of the content image substantially matches an end (for example, a left end) of the wall 6a.

An upper, lower, left, and right of the wall 6a in FIG. 1 are defined as an upper, lower, left, and right of a space in which the projection system 100 is provided. A wall 6b is a wall adjacent to the left end of the wall 6a and perpendicular to the wall 6a. A wall 6c is a wall adjacent to a right end of the wall 6a and perpendicular to the wall 6a. A ceiling 6d is a ceiling adjacent to an upper end of the wall 6a and perpendicular to the wall 6a. A floor 6e is a floor adjacent to a lower end of the wall 6a and perpendicular to the wall 6a.

In the example of FIG. 1, the projection apparatus 10 and the computer 50 are installed on the floor 6e, but each of the projection apparatus 10 and the computer 50 may be installed on a pedestal or the like installed on the floor 6e, or may be installed on the walls 6b and 6c, or the ceiling 6d by using an attachment tool. In the example of FIG. 1, the imaging device 30 is held by a person (not shown) by hand.

A projectable range 11 shown by a one-dot chain line is a range in which the projection can be performed by the projection apparatus 10.

### <Projection Apparatus 10>

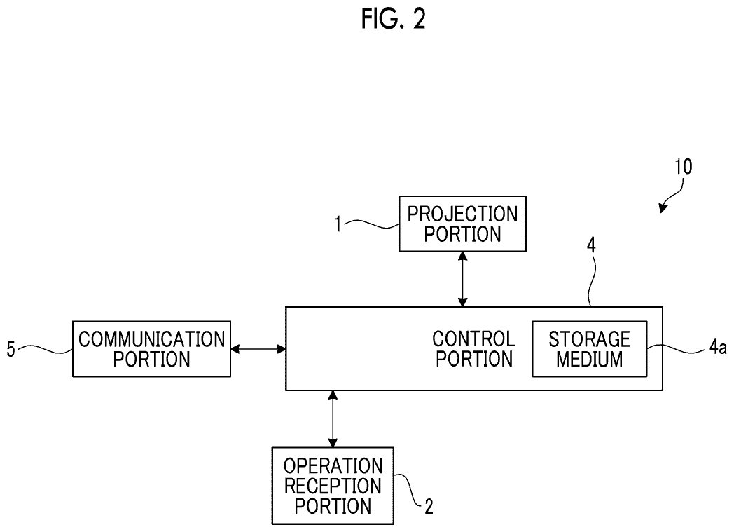

FIG. 2 is a diagram showing an example of the projection apparatus 10. Each projection apparatus 10 is composed of, for example, the projection apparatus 10 shown in FIG. 2. The projection apparatus 10 comprises a projection portion 1, a control portion 4, an operation reception portion 2, and a communication portion 5. The projection portion 1 is composed of, for example, a liquid crystal projector or a projector using liquid crystal on silicon (LCOS). Hereinafter, the projection portion 1 will be described as a liquid crystal projector.

The control portion 4 controls the projection performed by the projection apparatus 10. The control portion 4 is a device including a control portion composed of various processors, a communication interface (not shown) for communicating with each unit, and a storage medium 4a such as a hard disk, a solid state drive (SSD), or a read-only memory (ROM) and integrally controls the projection portion 1. Examples of the various processors of the control portion of the control portion 4 include a central processing unit (CPU) that is a general-purpose processor performing various types of processing by executing a program, a programmable logic device (PLD) such as a field programmable gate array (FPGA) that is a processor having a circuit configuration changeable after manufacture, or a dedicated electric circuit such as an application specific integrated circuit (ASIC) that is a processor having a circuit configuration dedicatedly designed to execute specific processing.

More specifically, a structure of these various processors is an electric circuit in which circuit elements such as semiconductor devices are combined. The control portion of the control portion 4 may be composed of one of the various processors or may be composed of a combination of two or more processors of the same type or different types (for example, a combination of a plurality of FPGAs or a combination of a CPU and an FPGA).

The operation reception portion 2 detects an instruction from a user (user instruction) by receiving various operations from the user. The operation reception portion 2 may be a button, a key, a joystick, or the like provided in the control portion 4 or may be a reception unit or the like that receives a signal from a remote controller that performs a remote operation of the control portion 4.

The communication portion 5 is a communication interface capable of communicating with the computer 50. The communication portion 5 may be a wired communication interface that performs wired communication as shown in FIG. 1, or may be a wireless communication interface that performs wireless communication.

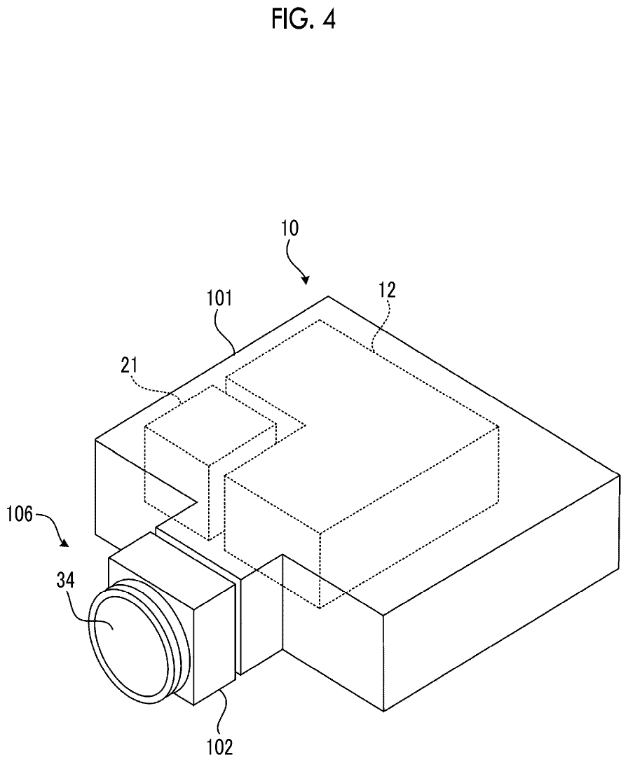

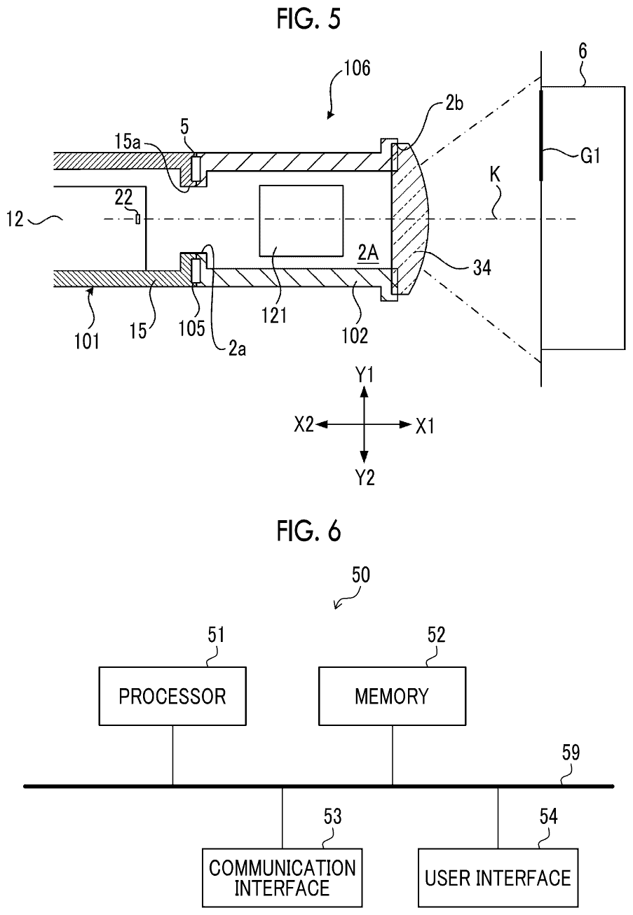

It should be noted that the projection portion 1, the control portion 4, and the operation reception portion 2 are implemented by, for example, one device (for example, refer to FIGS. 4 and 5). Alternatively, the projection portion 1, the control portion 4, and the operation reception portion 2 may be separate devices that cooperate by performing communication with each other.

### <Internal Configuration of Projection Portion 1>

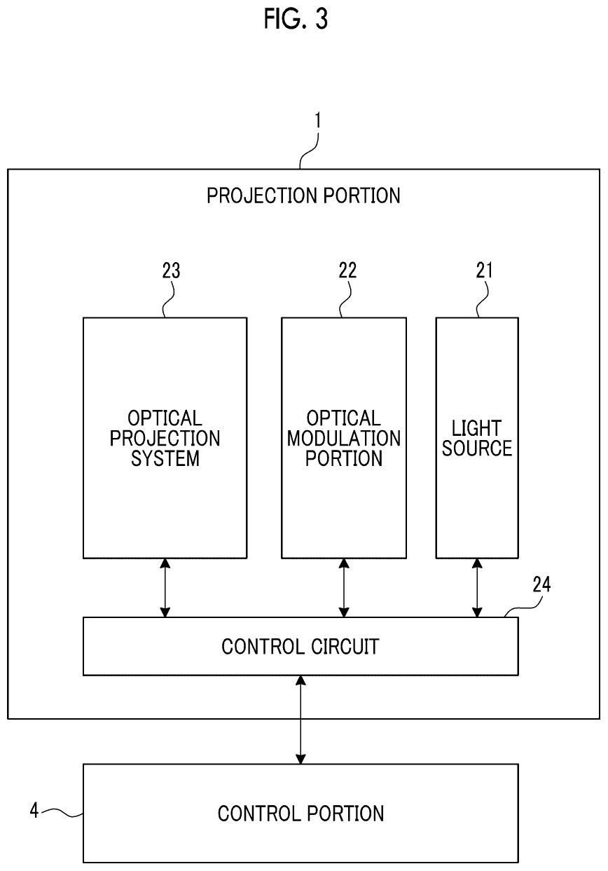

FIG. 3 is a schematic diagram showing an example of an internal configuration of the projection portion 1. As shown in FIG. 3, the projection portion 1 of the projection apparatus 10 shown in FIG. 2 comprises a light source 21, an optical modulation portion 22, an optical projection system 23, and a control circuit 24. The light source 21 includes a light emitting element such as a laser or a light emitting diode (LED) and emits, for example, white light.

The optical modulation portion 22 is composed of three liquid crystal panels (optical modulation elements) that emit each color image by modulating, based on image information, light of each color which is emitted from the light source 21 and separated into three colors, red, blue, and green, by a color separation mechanism, not shown, and a dichroic prism that mixes color images emitted from the three liquid crystal panels and that emits the mixed color image in the same direction. Each color image may be emitted by respectively mounting filters of red, blue, and green in the three liquid crystal panels and modulating the white light emitted from the light source 21 via each liquid crystal panel.

The light from the light source 21 and the optical modulation portion 22 is incident on the optical projection system 23. The optical projection system 23 is composed of, for example, a relay optical system including at least one lens. The light that has passed through the optical projection system 23 is projected to the projection target object (for example, the wall 6a).

In the projection target object, a region irradiated with the light transmitted through the entire range of the optical modulation portion 22 is the projectable range 11 within which the projection can be performed by the projection portion 1. For example, in the projectable range 11, a size, a position, and a shape of the projection range of the projection portion 1 are changed by controlling a size, a position, and a shape of a region through which the light is transmitted in the optical modulation portion 22.

The control circuit 24 controls the light source 21, the optical modulation portion 22, and the optical projection system 23 based on display data input from the control portion 4 to project an image based on the display data to the projection target object. The display data input into the control circuit 24 is composed of three pieces of data including red display data, blue display data, and green display data.

In addition, the control circuit 24 enlarges or reduces a projection range of the projection portion 1 by changing the optical projection system 23 based on a command input from the control portion 4. In addition, the control portion 4 may move the projection range of the projection portion 1 by changing the optical projection system 23 based on an operation received by the operation reception portion 2 from the user.

In addition, the projection apparatus 10 comprises a shift mechanism that mechanically or optically moves the projection range of the projection portion 1 while maintaining an image circle of the optical projection system 23. The image circle of the optical projection system 23 is a region in which the projection light incident on the optical projection system 23 appropriately passes through the optical projection system 23 in terms of light fall-off, color separation, edge part curvature, and the like.

The shift mechanism is implemented by at least any one of an optical system shift mechanism that performs optical system shifting, or an electronic shift mechanism that performs electronic shifting.

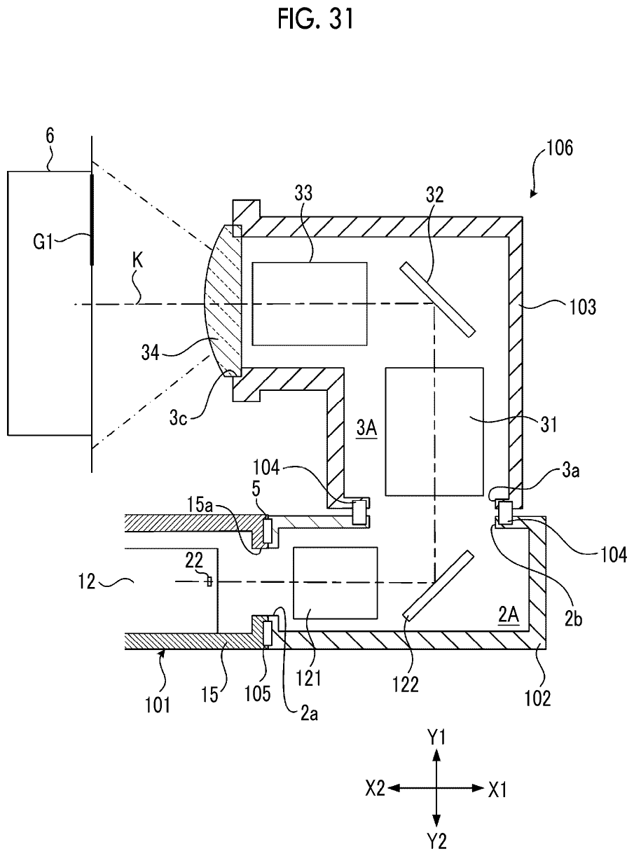

The optical system shift mechanism is, for example, a mechanism (for example, refer to FIGS. 5 and 31) that moves the optical projection system 23 in a direction perpendicular to an optical axis, or a mechanism that moves the optical modulation portion 22 in the direction perpendicular to the optical axis instead of moving the optical projection system 23. In addition, the optical system shift mechanism may perform the movement of the optical projection system 23 and the movement of the optical modulation portion 22 in combination with each other.

The electronic shift mechanism is a mechanism that performs pseudo shifting of the projection range by changing a range through which the light is transmitted in the optical modulation portion 22.

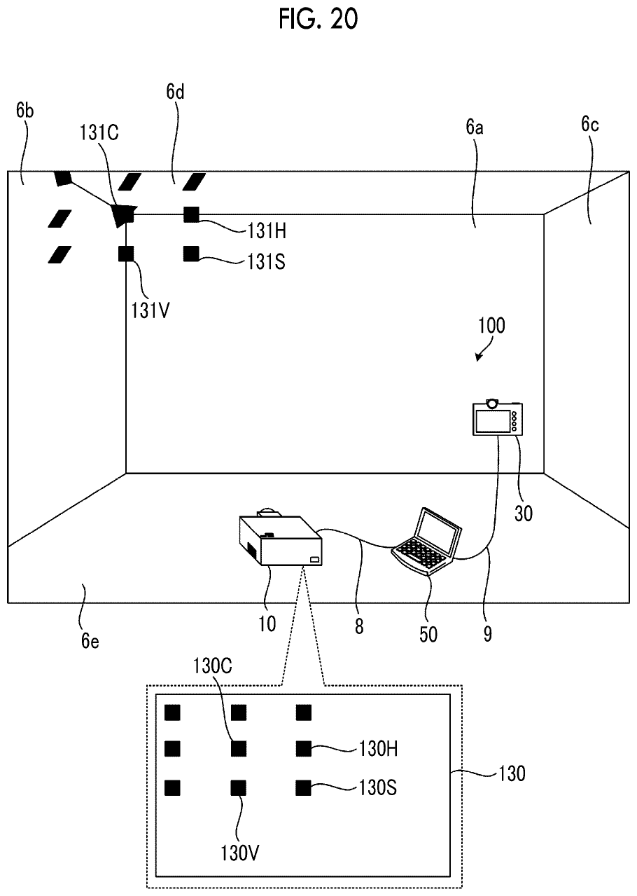

In addition, the projection apparatus 10 may comprise a projection direction changing mechanism that moves the image circle of the optical projection system 23 and the projection range. The projection direction changing mechanism is a mechanism that changes a projection direction of the projection portion 1 by changing an orientation of the projection portion 1 via mechanical rotation (for example, refer to FIG. 20).

### <Mechanical Configuration of Projection Apparatus 10>

FIG. 4 is a schematic diagram showing an exterior configuration of the projection apparatus 10. FIG. 5 is a schematic cross-sectional view of an optical unit 106 of the projection apparatus 10 shown in FIG. 4. FIG. 5 shows a cross section in a plane along an optical path of light emitted from a body part 101 shown in FIG. 4.

As shown in FIG. 4, the projection apparatus 10 comprises the body part 101 and the optical unit 106 that is provided to protrude from the body part 101. In the configuration shown in FIG. 4, the operation reception portion 2; the control portion 4; the light source 21, the optical modulation portion 22, and the control circuit 24 in the projection portion 1; and the communication portion 5 are provided in the body part 101. The optical projection system 23 in the projection portion 1 is provided in the optical unit 106.

The optical unit 106 comprises a first member 102 supported by the body part 101. The optical unit 106 may be configured to be attachable to and detachable from the body part 101 (in other words, configured to be interchangeable).

As shown in FIG. 5, the body part 101 includes a housing 15 in which an opening 15a for passing light is formed in a part connected to the optical unit 106.

As shown in FIG. 4, the light source 21 and an optical modulation unit 12 including the optical modulation portion 22 (refer to FIG. 3) that generates an image by spatially modulating the light emitted from the light source 21 based on input image data are provided inside the housing 15 of the body part 101. The light emitted from the light source 21 is incident on the optical modulation portion 22 of the optical modulation unit 12 and is spatially modulated and emitted by the optical modulation portion 22.

As shown in FIG. 5, the image formed by the light spatially modulated by the optical modulation unit 12 is incident on the optical unit 106 by passing through the opening 15a of the housing 15 and is projected to the projection target object 6 (for example, the wall 6a). Accordingly, an image G1 is visible from an observer.

As shown in FIG. 5, the optical unit 106 comprises the first member 102 having a hollow portion 2A connected to an inside of the body part 101, a first optical system 121 disposed in the hollow portion 2A, a lens 34, and a first shift mechanism 105.

The first member 102 is a member having, for example, a rectangular cross-sectional exterior, in which an opening 2a and an opening 2b are formed in surfaces parallel to each other. The first member 102 is supported by the body part 101 in a state where the opening 2a is disposed at a position facing the opening 15a of the body part 101. The light emitted from the optical modulation portion 22 of the optical modulation unit 12 of the body part 101 is incident into the hollow portion 2A of the first member 102 through the opening 15a and the opening 2a.

An incidence direction of the light incident into the hollow portion 2A from the body part 101 will be referred to as a direction X1. A direction opposite to the direction X1 will be referred to as a direction X2. The direction X1 and the direction X2 will be collectively referred to as a direction X. In addition, a direction from the front to the back of the page of FIG. 5 and its opposite direction will be referred to as a direction Z. In the direction Z, the direction from the front to the back of the page will be referred to as a direction Z1, and the direction from the back to the front of the page will be referred to as a direction Z2.

In addition, a direction perpendicular to the direction X and to the direction Z will be referred to as a direction Y. In the direction Y, an upward direction in FIG. 5 will be referred to as a direction Y1, and a downward direction in FIG. 5 will be referred to as a direction Y2. In the example in FIG. 5, the projection apparatus 10 is disposed such that the direction Y2 is a vertical direction.

The optical projection system 23 shown in FIG. 3 is composed of the first optical system 121 and the lens 34 in the example in FIG. 5. An optical axis K of this optical projection system 23 is shown in FIG. 5. The first optical system 121 and the lens 34 are disposed in this order from an optical modulation portion 22 side along the optical axis K.

The first optical system 121 includes at least one lens and guides the light that is incident on the first member 102 from the body part 101 and that travels in the direction X1 to the lens 34.

The lens 34 closes the opening 2b formed in an end part of the first member 102 on a direction X1 side and is disposed in the end part. The lens 34 projects the light incident from the first optical system 121 to the projection target object 6.

The first shift mechanism 105 is a mechanism for moving the optical axis K of the optical projection system 23 (in other words, the optical unit 106) in a direction (direction Y in FIG. 5) perpendicular to the optical axis K. Specifically, the first shift mechanism 105 is configured to be capable of changing a position of the first member 102 in the direction Y with respect to the body part 101. The first shift mechanism 105 may manually move the first member 102 or electrically move the first member 102.

FIG. 5 shows a state where the first member 102 is moved as far as possible to a direction Y1 side by the first shift mechanism 105. By moving the first member 102 in the direction Y2 via the first shift mechanism 105 from the state shown in FIG. 5, a relative position between a center of the image (in other words, a center of a display surface) formed by the optical modulation portion 22 and the optical axis K changes, and the image G1 projected to the projection target object 6 can be shifted (translated) in the direction Y2.

The first shift mechanism 105 may be a mechanism that moves the optical modulation portion 22 in the direction Y instead of moving the optical unit 106 in the direction Y. Even in this case, the image G1 projected to the projection target object 6 can be moved in the direction Y.

### <Hardware Configuration of Computer 50>

FIG. 6 is a diagram showing an example of a hardware configuration of the computer 50. As shown in FIG. 6, the computer 50 shown in FIG. 1 comprises a processor 51, a memory 52, a communication interface 53, and a user interface 54. The processor 51, the memory 52, the communication interface 53, and the user interface 54 are connected by, for example, a bus 59.

The processor 51 is a circuit that performs signal processing, and is, for example, a CPU that controls the entire computer 50. The processor 51 may be implemented by other digital circuits such as an FPGA and a digital signal processor (DSP). In addition, the processor 51 may be implemented by combining a plurality of digital circuits.

The memory 52 includes, for example, a main memory and an auxiliary memory. The main memory is, for example, a random-access memory (RAM). The main memory is used as a work area of the processor 51.

The auxiliary memory is, for example, a non-volatile memory such as a magnetic disk, an optical disc, or a flash memory. Various programs for operating the computer 50 are stored in the auxiliary memory. The programs stored in the auxiliary memory are loaded into the main memory and executed by the processor 51.

In addition, the auxiliary memory may include a portable memory that can be attached to and detached from the computer 50. Examples of the portable memory include a memory card such as a universal serial bus (USB) flash drive or a secure digital (SD) memory card, and an external hard disk drive.

The communication interface 53 is a communication interface that performs communication with an outside of the computer 50 (for example, the projection apparatus 10 or the imaging device 30). The communication interface 53 is controlled by the processor 51. The communication interface 53 may be a wired communication interface that performs wired communication or a wireless communication interface that performs wireless communication, or may include both of the wired communication interface and the wireless communication interface.

The user interface 54 includes, for example, an input device that receives operation input from a user, and an output device that outputs information to the user. The input device can be implemented by, for example, a pointing device (for example, a mouse), a key (for example, a keyboard), or a remote controller. The output device can be implemented by, for example, a display or a speaker. In addition, the input device and the output device may be implemented by a touch panel or the like. The user interface 54 is controlled by the processor 51.

### <Processing Performed by Computer 50>

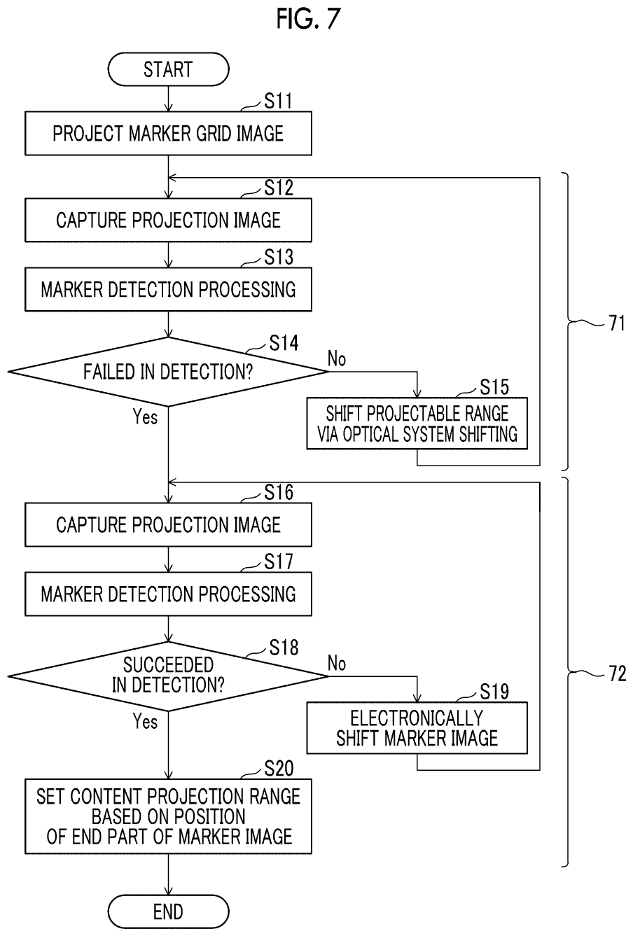

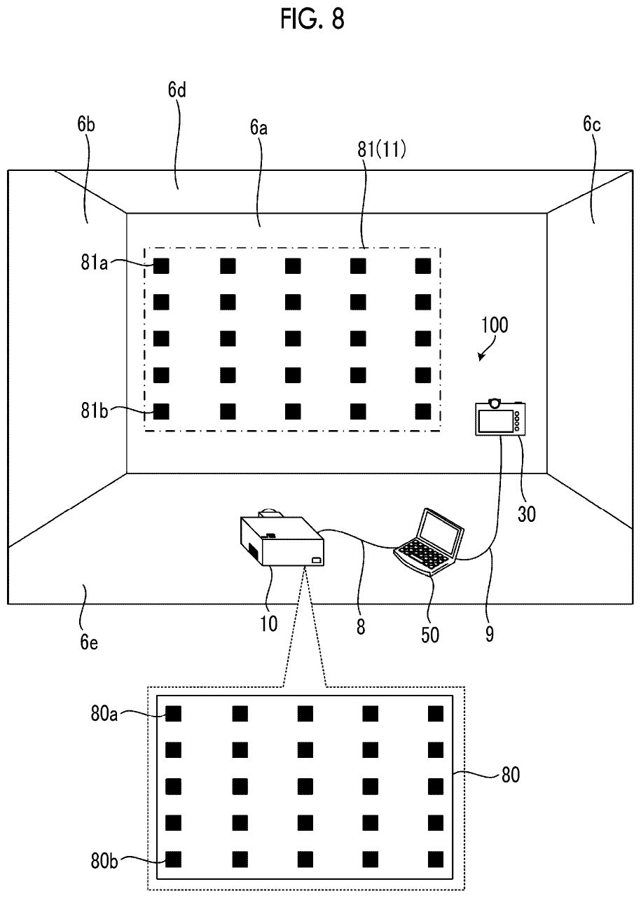

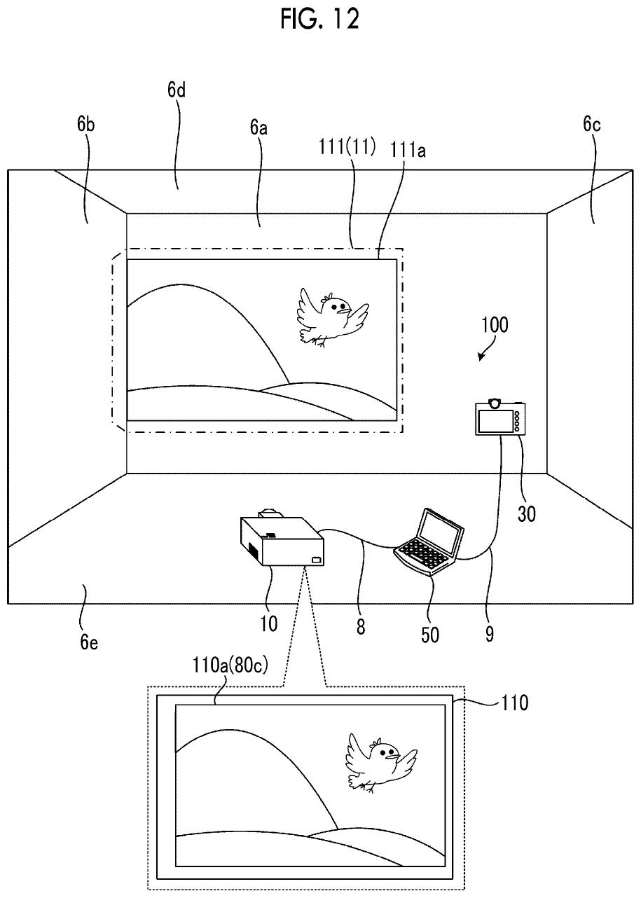

FIG. 7 is a flowchart showing an example of processing performed by the computer 50. FIGS. 8 to 11 are diagrams showing examples of a change in a projection state of the projection apparatus 10 due to the processing shown in FIG. 7. FIG. 12 is a diagram showing an example of projection of the content image onto a content projection range set by the processing shown in FIG. 7. Here, a case where the left end of the content projection image matches the left end of the wall 6a will be described. The computer 50 executes, for example, the processing shown in FIG. 7 in a state in which the projection apparatus 10 is installed in advance such that the projectable range 11 of the projection apparatus 10 is within a range of the wall 6a.

First, the computer 50 performs control of causing the projection apparatus 10 to project a marker grid image including a plurality of marker images two-dimensionally arranged (step S11). For example, as shown in FIG. 8, the computer 50 causes the projection apparatus 10 to project a marker grid image 80.

The marker grid image 80 is an image including 25 marker images arranged in a 5×5 matrix. The 25 marker images included in the marker grid image 80 are an example of a first image according to the embodiment of the present invention. It should be noted that, although the 25 marker images included in the marker grid image 80 are actually different markers, all the marker images are shown as the same marker (black rectangle). A marker image 80a is a marker image at an upper left end of the marker grid image 80. A marker image 80b is a marker image at a lower left end of the marker grid image 80.

A marker grid projection image 81 shown in FIG. 8 is an image projected onto the projectable range 11 of the projection target object (for example, the wall 6a) by the projection apparatus 10 projecting the marker grid image 80. Marker projection images 81a and 81b are projection images corresponding to the marker images 80a and 80b, respectively.

Next, the computer 50 performs projectable range specifying processing 71 for specifying the projectable range 11. The projectable range specifying processing 71 is an example of first control according to the embodiment of the present invention. As the projectable range specifying processing 71, the computer 50 first performs control of causing the imaging device 30 to capture the projection image (for example, the marker grid projection image 81 of FIG. 8) of the marker grid image projected in step S11 (step S12). Control of causing the imaging device 30 to capture the projection image will be described below.

Next, the computer 50 performs marker detection processing of detecting the 25 marker images included in the marker grid image 80 from imaging data obtained by the imaging in step S12 (step S13). Various types of image recognition processing can be used for the marker detection processing.

Next, the computer 50 determines whether or not the computer 50 has failed in the detection of at least any one of all the marker images included in the marker grid image 80 in the marker detection processing of step S13 (step S14). In a case where the computer 50 has succeeded in the detection of all the marker images (step S14: No), the computer 50 shifts the projectable range 11 in a left direction by a predetermined first unit amount 41 via the optical system shifting (step S15), and returns to step S12. The left direction in this case is an example of a first direction according to the embodiment of the present invention.

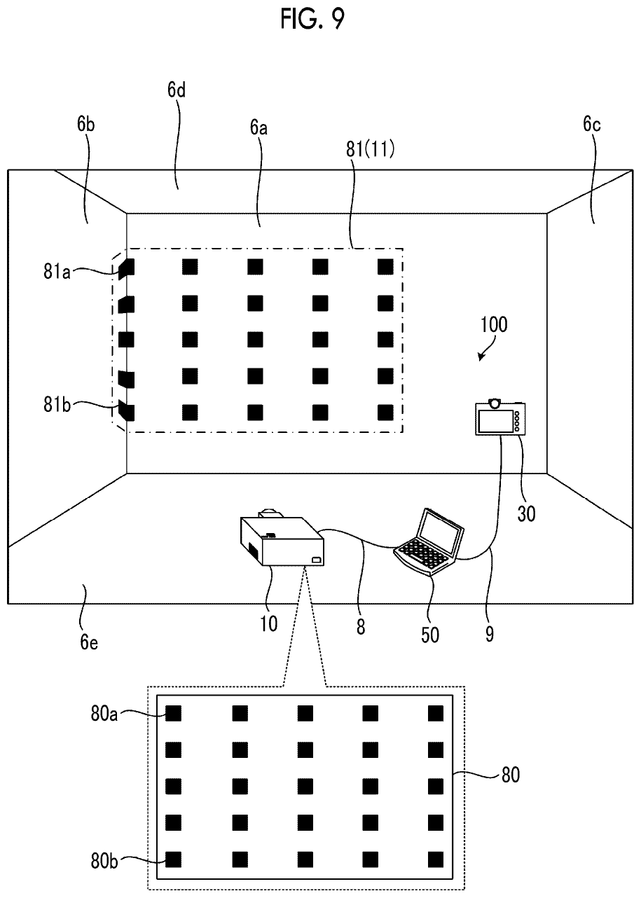

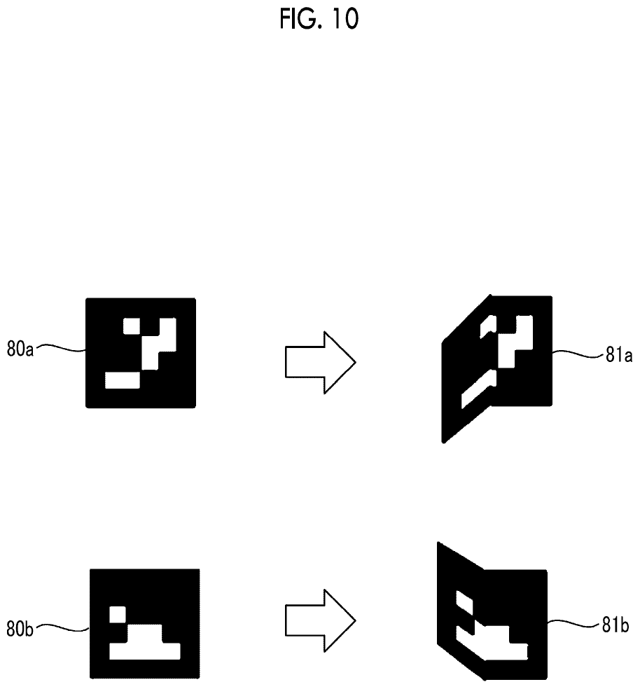

In step S14, in a case where the computer 50 has failed in the detection of at least any one of the marker images (step S14: Yes), the marker grid projection image 81 is in, for example, a state shown in FIG. 9. Specifically, a left end of the marker grid projection image 81 protrudes from the wall 6a and is projected onto the wall 6b, and the marker image at the left end of the marker grid projection image 81 including the marker projection images 81a and 81b is in a state of being across a boundary between the wall 6a and the wall 6b. In a case where the planarity of the marker image is lost in this way, a marker shape cannot be restored because of projective transformation or the like in the image recognition processing, and thus the marker detection is generally difficult. Therefore, in the marker detection processing of step S13, the computer 50 fails in the detection of these marker images. For example, it is assumed that the marker images 80a and 80b are markers (ArUco markers) as shown in FIG. 10. In this case, in imaging data obtained in the state of FIG. 9, the marker projection images 81a and 81b have greatly distorted shapes as shown in FIG. 10.

In this case, the computer 50 ends the projectable range specifying processing 71 and performs content projection range specifying processing 72 for specifying the content projection range onto which the content image is projected in the projectable range 11. The content projection range specifying processing 72 is an example of second control according to the embodiment of the present invention. As the content projection range specifying processing 72, first, the computer 50 performs the control of causing the imaging device 30 to capture the projection image (for example, the marker grid projection image 81 of FIG. 9) of the marker grid image projected in step S11 in the same manner as in step S12 (step S16).

Next, the computer 50 performs marker detection processing of detecting the 25 marker images included in the marker grid image 80 from the imaging data obtained by the imaging in step S16, in the same manner as in step S13 (step S17). The marker detection processing may be performed based on the imaging data of one frame, or may be performed based on the imaging data of a plurality of frames.

Next, the computer 50 determines whether or not the computer 50 has succeeded in the detection of all the marker images included in the marker grid image 80 in the marker detection processing of step S17 (step S18). In a case where the computer 50 has failed in the detection of at least any one of the marker images (step S18: No), the computer 50 electronically shifts the marker image of the marker grid image 80 in a right direction by a predetermined second unit amount 42 (step S19), and returns to step S16.

The second unit amount 42 is a unit amount smaller than the above-described first unit amount 41. The second unit amount 42 may be, for example, a shift amount of one pixel or may be a shift amount of a plurality of pixels. In addition, the second unit amount 42 may be settable by the user. The right direction in this case is an example of a second direction according to the embodiment of the present invention.

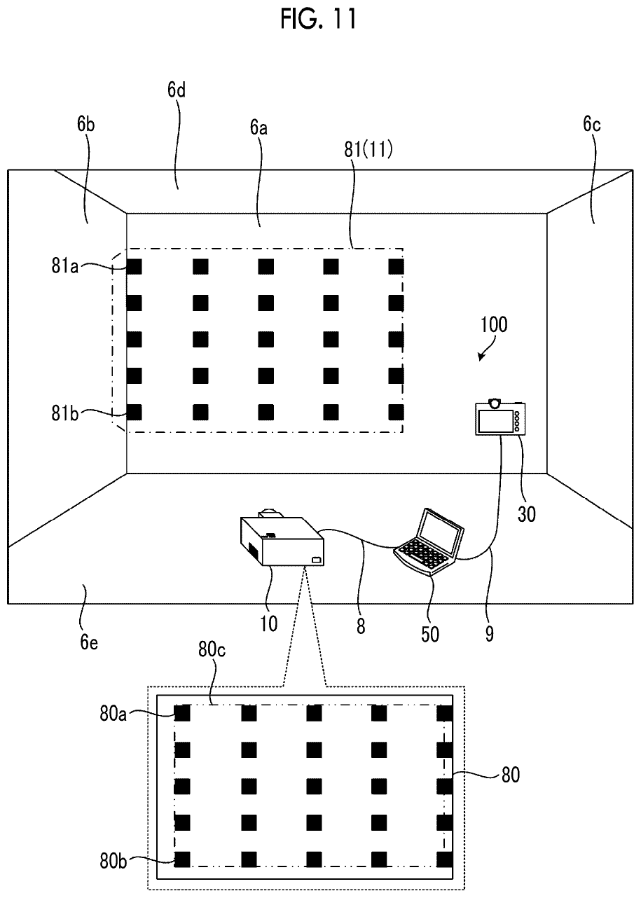

In step S18, in a case where the computer 50 has succeeded in the detection of all the marker images (step S18: Yes), the marker grid projection image 81 is in a state shown in, for example, FIG. 11. Specifically, the left end of the marker projection image at the left end of the marker grid projection image 81 substantially matches the left end of the wall 6a.

In this case, the computer 50 sets a content projection range 80c based on a position of an end part of the marker image included in the current marker grid image 80 (step S20), and ends the content projection range specifying processing 72. In step S20, for example, as shown in FIG. 11, the computer 50 sets the content projection range 80c such that a position of a left end of the marker image at the left end of the current marker grid image 80 is a position of a left end of the content projection range 80c.

After the processing shown in FIG. 7, the computer 50 performs control of causing the projection apparatus 10 to project the content image onto the content projection range 80c set in step S20. For example, as shown in FIG. 12, the computer 50 performs control of causing the projection apparatus 10 to project a projection image 110 in which a content image 110a is disposed onto the content projection range 80c.

Specifically, in the computer 50 or the projection apparatus 10, the content image 110a is subjected to geometric transformation (for example, reduction processing) in accordance with the content projection range 80c, and the geometrically transformed content image 110a is projected from the projection apparatus 10. A projection image 111 is a projection image corresponding to the projection image 110. A content projection image 111a is a projection image corresponding to the content image 110a. As shown in FIG. 12, a left end of the content projection image 111a substantially matches the left end of the wall 6a.

### <Regarding Control of Causing Imaging Device 30 to Capture Projection Image>

The control of causing the imaging device 30 to capture the projection image in steps S12 and S16 shown in FIG. 7 is, for example, control of prompting the user who holds the imaging device 30 to capture the projection image with the imaging device 30. For example, the computer 50 performs control of outputting a message for prompting the capturing of the projection image with the imaging device 30, via the projection performed by the projection apparatus 10, display or audio output performed by the computer 50 or the imaging device 30, or the like. Alternatively, the control of causing the imaging device 30 to capture the projection image may be, for example, control of transmitting a control signal for instructing the imaging device 30 to capture the projection image.

In addition, the computer 50 receives the imaging data of the projection image obtained by the imaging in steps S12 and S16 from the imaging device 30. Transmission of the imaging data performed by the imaging device 30 may be automatically performed by the imaging device 30 by a trigger indicating that the imaging of the imaging device 30 is performed, or may be performed by a user operation after the imaging of the imaging device 30.

Alternatively, the imaging performed by the imaging device 30 may be automatically performed. For example, in the processing shown in FIG. 7, the imaging device 30 may repeatedly perform imaging (for example, motion picture imaging), and the computer 50 may acquire imaging data at the timing from the imaging device 30 in steps S12 and S16.

As described above, the computer 50 determines the continuity of the projection image of the first image based on the imaging data of the projection image (marker grid projection image 81) of the first image (the plurality of marker images included in the marker grid image 80) projected by the projection apparatus 10. The determination of the continuity of the projection image of the first image can be performed, for example, by using the plurality of marker images two-dimensionally arranged as the first image and by detecting the marker images based on the imaging data.

Then, the computer 50 performs the first control (projectable range specifying processing 71) of moving a boundary of the projection range (projectable range 11) of the projection apparatus 10 in the first direction (for example, the left direction) to the first direction until it is determined that the continuity is not present. As a result, an end part of the projection range of the projection apparatus 10 can be set to a state of slightly protruding from an end part of a continuous projection target range (wall 6a).

In addition, the computer 50 performs the second control (content projection range specifying processing 72) of moving the projection range of the first image to the second direction (for example, the right direction) opposite to the first direction via image processing until it is determined that the continuity is present, after the first control. As a result, a position corresponding to an end part of the continuous projection target range (wall 6a) in the projection range of the projection apparatus 10 can be specified. Therefore, in a case where the content image 110a is projected from the projection apparatus 10, it is possible to accurately match an end part of the content projection image 111a with the end part of the continuous projection target range (wall 6a).

As a result, for example, an effective spatial production with a sense of immersion can be performed. In addition, the continuous projection target range can be used for the projection of the content image without waste. In addition, for example, the equipment cost and the work load can be reduced as compared with a method of using a detection device capable of spatial recognition, such as a depth camera or light detection and ranging (LiDAR), or a fixing member, such as a tripod, for fixing these. In addition, even in a case where there is a physical constraint in a space and a fixing member such as a tripod cannot be used, the adjustment can be performed by using the hand-held imaging device 30.

The control of shifting the projection range of the projection apparatus 10 has been described as the control of moving the boundary of the projection range (projectable range 11) of the projection apparatus 10 in the first direction (left direction) to the first direction, but the present invention is not limited to such control. For example, the computer 50 may move the boundary of the projection range of the projection apparatus 10 in the first direction to the first direction by enlarging the projection range of the projection apparatus 10 or by enlarging and shifting the projection range of the projection apparatus 10.

Similarly, the control of shifting the content projection range 80c has been described as the control of moving the boundary of the content projection range 80c in the first direction (left direction) to the second direction (right direction) via the image processing, the present invention is not limited to such control. For example, the computer 50 may move the boundary of the content projection range 80c in the first direction (left direction) to the second direction (right direction) by reducing the content projection range 80c via the image processing or by reducing and shifting the content projection range 80c via the image processing.

Here, the adjustment of matching the left end of the content projection range 80c with the left end of the wall 6a has been described, but similarly, adjustment of matching an upper end of the content projection range 80c with the upper end of the wall 6a, adjustment of matching a right end of the content projection range 80c with the right end of the wall 6a, or adjustment of matching a lower end of the content projection range 80c with the lower end of the wall 6a can also be performed.

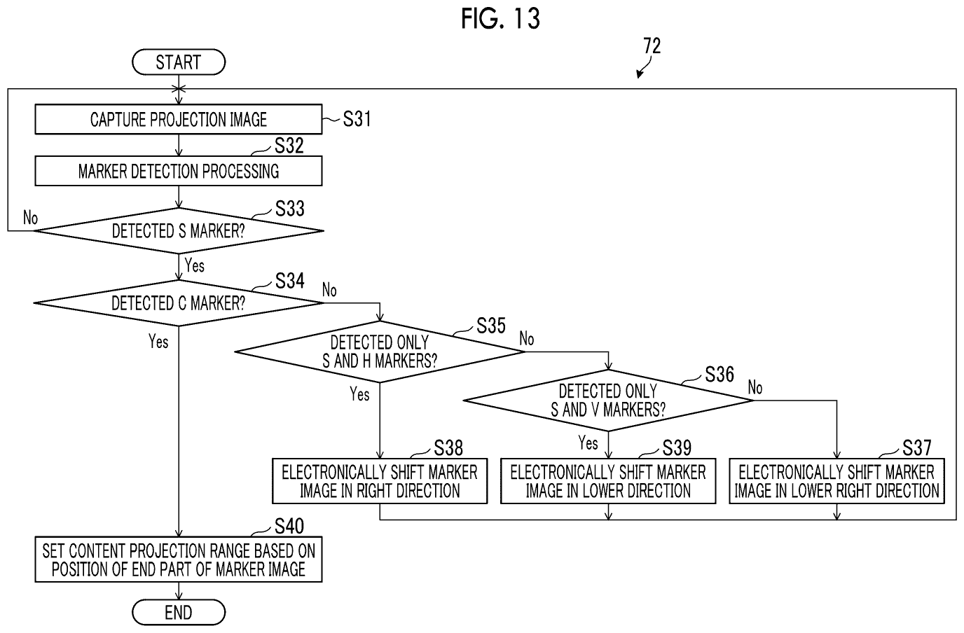

In addition, adjustment of matching the plurality of ends of the content projection range 80c with the ends of the wall 6a can also be performed. For example, a state in which the left end of the content projection range 80c matches the left end of the wall 6a and the upper end of the content projection range 80c matches the upper end of the wall 6a can be made by performing the adjustment of matching the left end of the content projection range 80c with the left end of the wall 6a, and then performing the adjustment of matching the upper end of the content projection range 80c with the upper end of the wall 6a while maintaining an optically shifted position and an electronically shifted position in a horizontal direction. It should be noted that the adjustment of matching the left end of the content projection range 80c with the left end of the wall 6a and the adjustment of matching the upper end of the content projection range 80c with the upper end of the wall 6a may be performed in parallel (for example, refer to FIG. 13).

In addition, for example, in the first control, the projectable range 11 may be enlarged such that the upper, lower, left, and right ends of the projectable range 11 of the projection apparatus 10 protrude from the wall 6a, and in the second control, the adjustment of matching the upper, lower, left, and right ends of the content projection range 80c with the upper, lower, left, and right ends of the wall 6a by reducing the content projection range 80c may be performed. As a result, the range of the wall 6a and a range of the content projection image 111a substantially match each other, and more effective spatial production can be performed.

### <Another Example of Content Projection Range Specifying Processing 72>

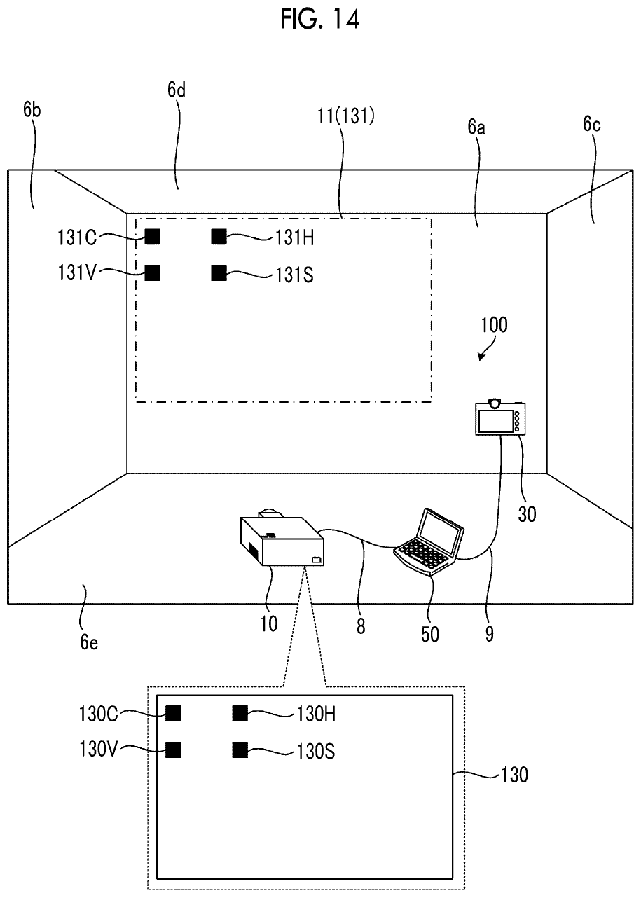

FIG. 13 is a flowchart showing still another example of the content projection range specifying processing 72. FIGS. 14 to 18 are diagrams showing examples of a change in the projection state of the projection apparatus 10 due to the processing shown in FIG. 13. Here, a case where an upper left end of the content projection image matches an upper left end of the wall 6a will be described. Instead of the content projection range specifying processing 72 of the processing shown in FIG. 7, the computer 50 may execute, for example, the content projection range specifying processing 72 shown in FIG. 13.

In this example, as shown in FIG. 14, the computer 50 causes the projection apparatus 10 to project a marker grid image 130. The marker grid image 130 is an image including four marker images arranged in a 2×2 matrix near an upper left end. The four marker images included in the marker grid image 130 are an example of a first image according to the embodiment of the present invention. It should be noted that, although the four marker images included in the marker grid image 130 are actually different markers, all the marker images are shown as the same marker (black rectangle).

Among the four marker images included in the marker grid image 130, an upper left marker image is referred to as a C marker 130C (corner marker), an upper right marker image is referred to as an H marker 130H (horizontal movement instruction marker), a lower left marker image is referred to as a V marker 130V (vertical movement instruction marker), and a lower right marker image is referred to as an S marker 130S (start marker).

The marker grid projection image 131 shown in FIG. 14 is an image projected onto the projectable range 11 of the projection target object (for example, the wall 6a) by the projection apparatus 10 projecting the marker grid image 130. A C marker projection image 131C, a V marker projection image 131V, an H marker projection image 131H, and an S marker projection image 131S are projection images corresponding to the C marker 130C, the V marker 130V, the H marker 130H, and the S marker 130S, respectively.

In the state shown in FIG. 14, the computer 50 performs the projectable range specifying processing 71 shown in FIG. 7 for each of the left direction and an upper direction. For example, the computer 50 first performs the projectable range specifying processing 71 in the left direction, so that the C marker projection image 131C and the V marker projection image 131V are in a state of being across different planes (the wall 6a and the wall 6b), and the projectable range specifying processing 71 in the left direction is ended by failing to detect the C marker 130C and the V marker 130V. Next, the computer 50 performs the projectable range specifying processing 71 in the upper direction by using the H marker 130H and the S marker 130S that the computer 50 has not failed to detect, so that the H marker projection image 131H is also in a state of being across different planes (the wall 6a and the ceiling 6d), and the projectable range specifying processing 71 in the upper direction is ended by failing to detect the H marker 130H.

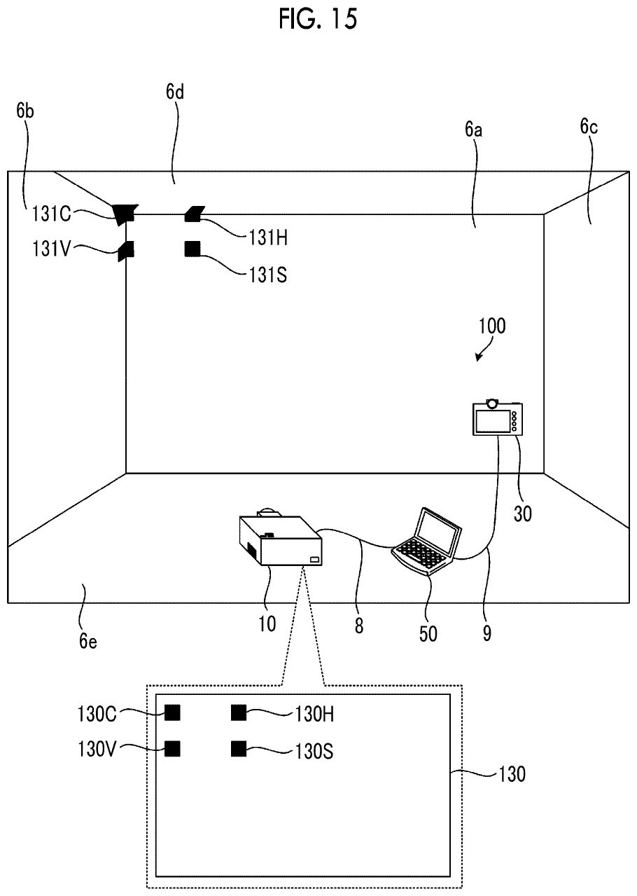

As a result, the projectable range 11 is in a state of protruding to the left side and the upper side with respect to the wall 6a, and is in a state shown in FIG. 15, for example. In this state, only the S marker projection image 131S is not in a state of being across different planes, and the S marker 130S can be detected. The projectable range 11 is not shown in FIGS. 15 to 21.

In this state, the computer 50 executes, for example, the content projection range specifying processing 72 shown in FIG. 13. Steps S31 to S32 shown in FIG. 13 are the same as steps S16 to S17 shown in FIG. 7. Next, after step S32, the computer 50 determines whether or not the S marker 130S has been detected via the marker detection processing of step S32 (step S33). In a case where the S marker 130S has not been detected (step S33: No), the computer 50 returns to step S31.

In step S33, in a case where the S marker 130S has been detected (step S33: Yes), the computer 50 determines whether or not the C marker 130C has been detected via the marker detection processing of step S32 (step S34). In a case where the C marker 130C has not been detected (step S34: No), the computer 50 determines whether or not it is a state in which only the S marker 130S and the H marker 130H have been detected via the marker detection processing of step S32 (step S35).

In step S35, in a case where it is not the state in which only the S marker 130S and the H marker 130H have been detected (step S35: No), the computer 50 determines whether or not it is a state in which only the S marker 130S and the V marker 130V have been detected via the marker detection processing of step S32 (step S36).

In step S36, in a case where it is not the state in which only the S marker 130S and the V marker 130V have been detected (step S36: No), it is a state in which only the S marker 130S has been detected, that is, for example, a state as shown in FIG. 15 is present. In this case, the computer 50 electronically shifts the marker image of the marker grid image 130 in a lower right direction by the predetermined second unit amount 42 (step S37), and returns to step S31.

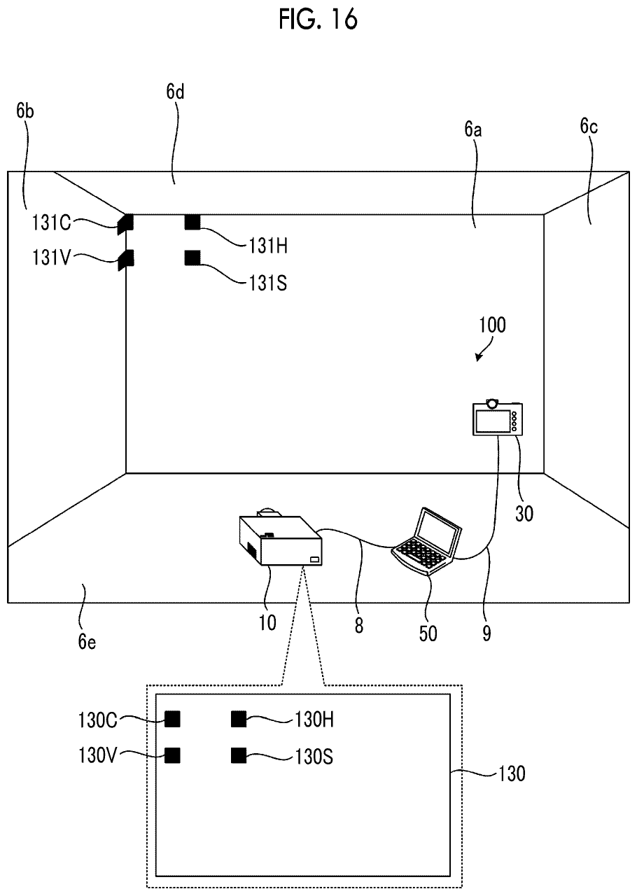

In step S35, in a case where it is the state in which only the S marker 130S and the H marker 130H have been detected (step S35: Yes), for example, as shown in FIG. 16, it is a state in which upper ends of the H marker projection image 131H and the C marker projection image 131C match the upper end of the wall 6a, but the C marker projection image 131C and the V marker projection image 131V protrude from the wall 6a to a left side. In this case, the computer 50 electronically shifts the marker image of the marker grid image 130 in the right direction by the predetermined second unit amount 42 (step S38), and returns to step S31.

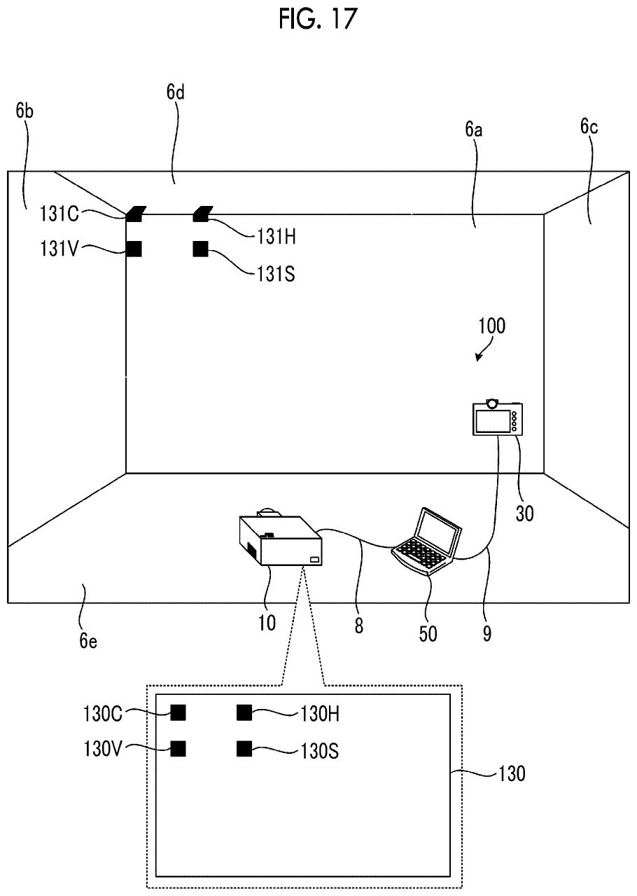

In step S36, in a case where it is the state in which only the S marker 130S and the V marker 130V have been detected (step S36: Yes), for example, as shown in FIG. 17, left ends of the C marker projection image 131C and the V marker projection image 131V match the left end of the wall 6a, but the C marker projection image 131C and the H marker projection image 131H protrude from the wall 6a to an upper side. In this case, the computer 50 electronically shifts the marker image of the marker grid image 130 in a lower direction by the predetermined second unit amount 42 (step S39), and returns to step S31.

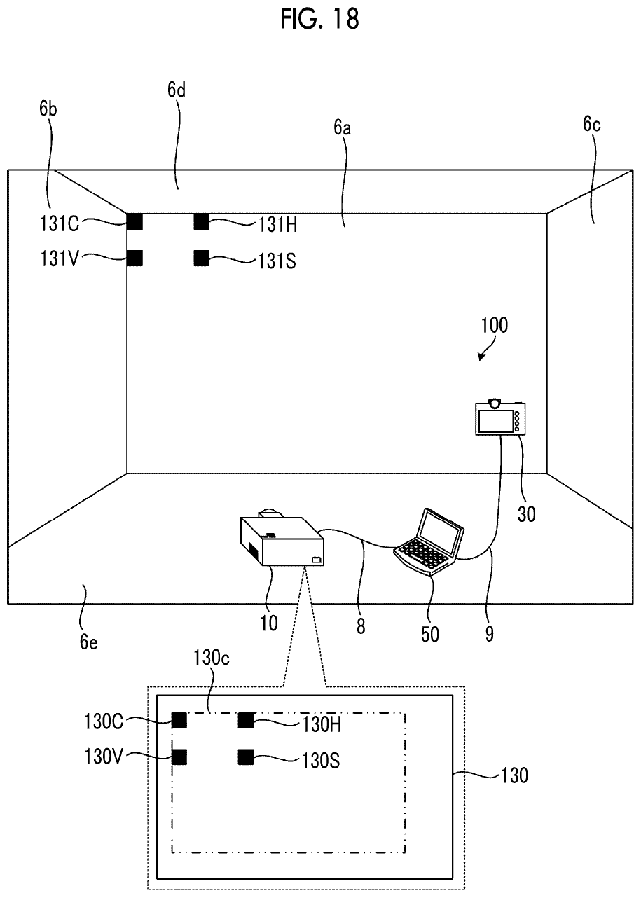

In step S34, in a case where the C marker 130C has been detected (step S34: Yes), for example, as shown in FIG. 18, the upper ends of the H marker projection image 131H and the C marker projection image 131C match the upper end of the wall 6a, and the left ends of the C marker projection image 131C and the V marker projection image 131V match the left end of the wall 6a. In this case, the computer 50 sets the content projection range 130c based on a position of at least any one of the C marker 130C, the V marker 130V, the H marker 130H, or the S marker 130S (step S40), and ends the content projection range specifying processing 72.

In step S40, for example, as shown in FIG. 18, the computer 50 sets the content projection range 130c such that a current position of a left end of at least any one of the C marker 130C or the V marker 130V is a position of a left end of the content projection range 130c. In addition, the computer 50 sets the content projection range 130c such that a current position of an upper end of at least any one of the C marker 130C or the H marker 130H is a position of an upper end of the content projection range 130c.

As shown in FIG. 13, in the content projection range specifying processing 72, the computer 50 repeatedly performs processing of moving the positions of the C marker 130C, the V marker 130V, the H marker 130H, and the S marker 130S while determining the presence or absence of the H marker 130H and the V marker 130V in response to the detection of the S marker 130S as a trigger, until the C marker 130C (corner) is detected.

In this way, by starting, in response to detection of another marker (S marker 130S) located around or next to an attention marker (C marker 130C, V marker 130V, and H marker 130H) for setting an end part of the content projection range 130c as a trigger, detection processing of the attention marker, it is possible to prevent erroneous determination or an erroneous operation even in a case where imaging is performed with the imaging device 30 in a completely different direction, for example.

After the processing shown in FIG. 13, the computer 50 performs control of causing the projection apparatus 10 to project the content image onto the content projection range 130c set in step S40. The projection of the content image onto the content projection range 130c is the same as the projection of the content image onto the content projection range 80c shown in FIG. 12. As a result, the upper left end of the content projection image substantially matches the upper left end of the wall 6a.

In step S37, the computer 50 may electronically shift the marker image of the marker grid image 130 in the right direction as in step S38 in a case where only the S marker 130S and the H marker 130H have been detected in an immediately preceding loop, and may electronically shift the marker image of the marker grid image 130 in the lower direction as in step S39 in a case where only the S marker 130S and the V marker 130V have been detected in the immediately preceding loop.

In the examples of FIGS. 13 to 18, a case where the upper left end of the content projection image matches the upper left end of the wall 6a has been described, but the end parts can be matched in the same manner for the remaining three corners (upper right, lower left, and lower right). For example, in a case where the upper right end of the content projection image matches the upper right end of the wall 6a, the computer 50 sets a positional relationship between the C marker 130C, the V marker 130V, the H marker 130H, and the S marker 130S to a left-right inversion of the examples of FIGS. 14 to 18. In addition, the direction of the electronic shifting is left in step S38 of FIG. 13 and is lower left in step S37.

As described above, the computer 50 may perform the projectable range specifying processing 71 and the content projection range specifying processing 72 for each of a plurality of directions by using the plurality of directions different from each other as the first direction. In this case, the computer 50 performs the content projection range specifying processing 72 for the plurality of directions based on the detection processing of the plurality of marker images different from each other. As a result, the adjustment in the plurality of directions can be efficiently performed.

<Projection Control in Case where S Marker 130S Cannot be Detected in Processing of FIG. 13>

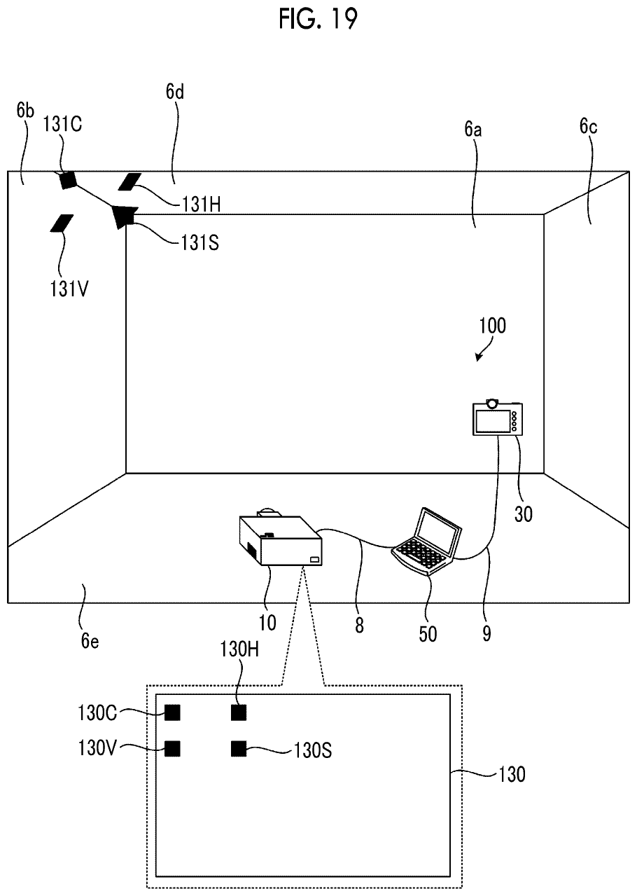

FIGS. 19 to 21 are diagrams showing examples of projection control in a case where the S marker 130S cannot be detected in the processing of FIG. 13. For example, as shown in FIG. 19, in a case where the S marker projection image 131S is also in a state of being across different planes (the wall 6a, the wall 6b, and the ceiling 6d), the S marker 130S is not detected in steps S31 to S33 of FIG. 13.

On the other hand, in steps S31 to S33 of FIG. 13, in a case where the S marker 130S is not detected for a certain time or longer, the computer 50 adds a marker image of the marker grid image 130, for example, as shown in FIG. 20. In the example of FIG. 20, the computer 50 causes the projection apparatus 10 to project the marker grid image 130 including nine marker images arranged in a 3×3 matrix in which one column of marker images is added to the right and one row is added below as compared with the example of the marker grid image 130 of FIGS. 14 to 18.

In addition, among the nine marker images, the computer 50 uses the lower right marker image as a new S marker 130S, uses a marker image above the S marker 130S as a new H marker 130H, uses a marker image on the left of the S marker 130S as a new V marker 130V, and uses a center marker image as a new marker grid image 130. That is, as compared with the examples of the marker grid image 130 of FIGS. 14 to 18, the C marker 130C, the V marker 130V, the H marker 130H, and the S marker 130S are shifted to the lower right.

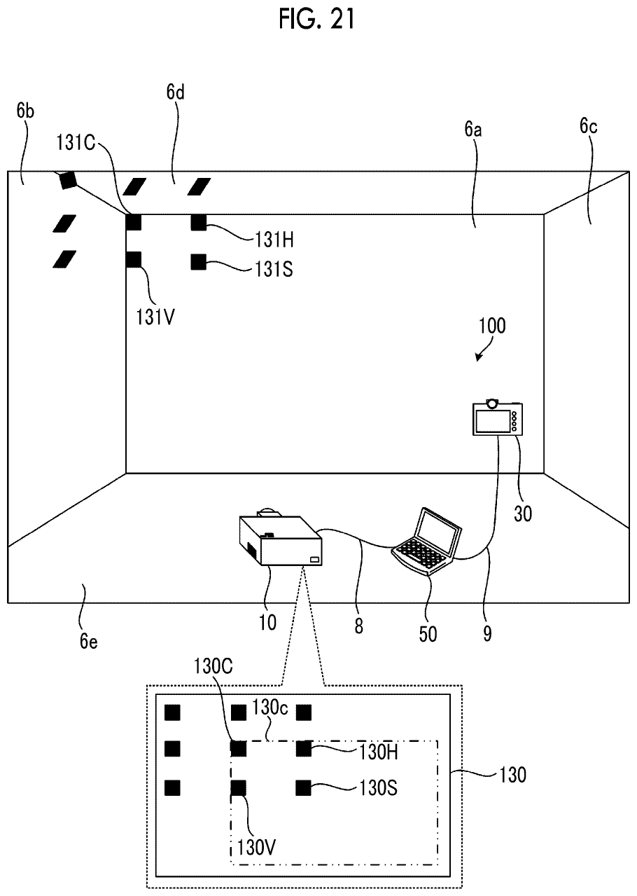

As a result, the S marker 130S can be detected, and a state shown in FIG. 21 can be set, for example, via the processing shown in FIG. 13. In this case, in step S40 of FIG. 13, the computer 50 sets the content projection range 130c based on a position of at least any one of the new C marker 130C, the new V marker 130V, the new H marker 130H, or the new S marker 130S.

As described above, in the content projection range specifying processing 72, the computer 50 may perform the processing of adding a marker image in a case where none of the plurality of marker images is detected. As a result, even in a state in which none of the plurality of marker images are detected via the content projection range specifying processing 72, it is possible to set a state in which some marker images can be detected.

<State in which Projectable Range Specifying Processing 71 is Performed in State in which Projectable Range 11 is Inclined>

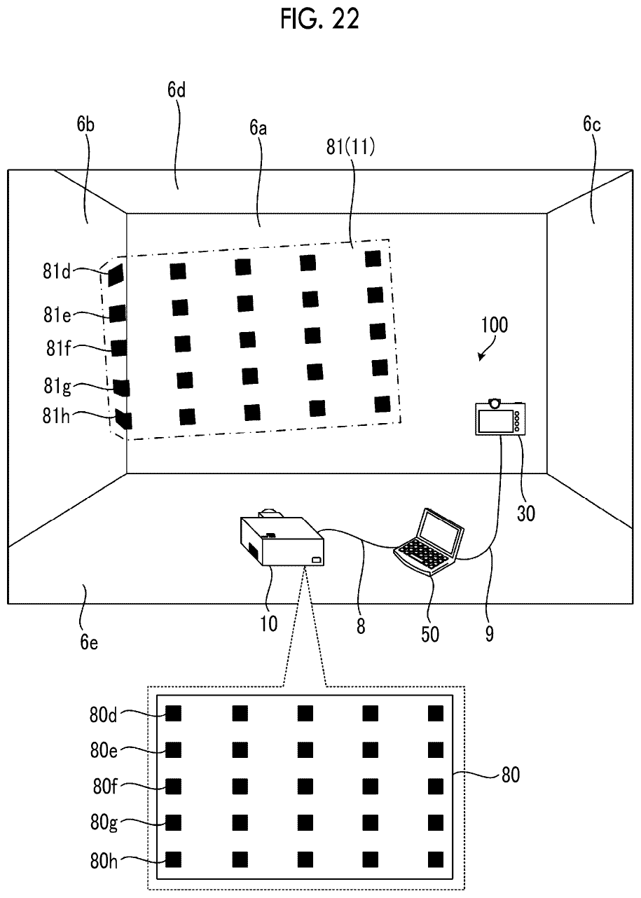

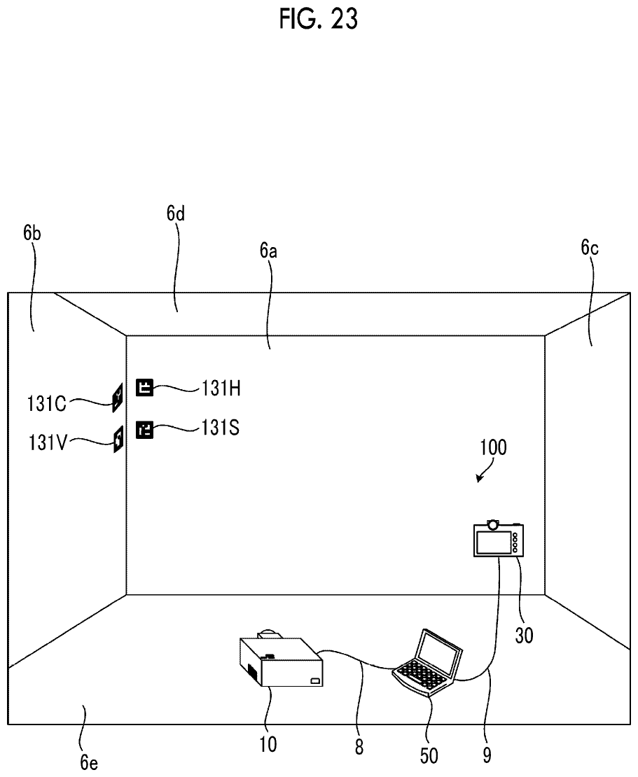

FIG. 22 is a diagram showing an example of a state in which the projectable range specifying processing 71 is performed in a state in which the projectable range 11 is inclined. FIG. 23 is a diagram showing another example of a state in which the projectable range specifying processing 71 is performed in a state in which the projectable range 11 is inclined.

For example, in a case where the projection apparatus 10 is not placed horizontally or the boundary between the wall 6a and the wall 6b is inclined, the projectable range 11 is inclined with respect to the boundary between the wall 6a and the wall 6b, for example, as shown in FIG. 22.

In a case where the projectable range specifying processing 71 is executed in this state, only some marker projection images among the marker projection images 81d to 81h corresponding to the five marker images 80d to 80h at the left end of the marker grid image 80 may be in a state of being across the boundary between the wall 6a and the wall 6b. For example, in the example of FIG. 22, the two lower marker projection images 81g and 81h are across the boundary between the wall 6a and the wall 6b as expected, but the three upper marker projection images 81d to 81f are projected only onto the wall 6b. In this case, the marker projection images 81d to 81f projected only on the wall 6b may be detected in the marker detection processing based on the imaging data of the imaging device 30.

In the example of FIG. 23, as in the examples of FIGS. 14 to 18, the marker grid image 130 including the C marker 130C, the V marker 130V, the H marker 130H, and the S marker 130S is projected, but the C marker projection image 131C and the V marker projection image 131V are projected only onto the wall 6b without being across the boundary between the wall 6a and the wall 6b, and the C marker 130C, the V marker 130V, the H marker 130H, and the S marker 130S are all detected. In a case where the processing of FIG. 13 is executed in this state, the S marker 130S and the C marker 130C are detected, so that the content projection range specifying processing 72 may be ended at the timing, and a position that protrudes to the wall 6b may be set as the left end of the content projection range 130c.

On the other hand, the computer 50 determines whether or not the marker projection images are present on the same plane, for example, by using information on the respective vertices of the C marker projection image 131C and the S marker projection image 131S.

### <Specific Example of Determination of Whether or not Plurality of Marker Projection Images are Present on the Same Plane>

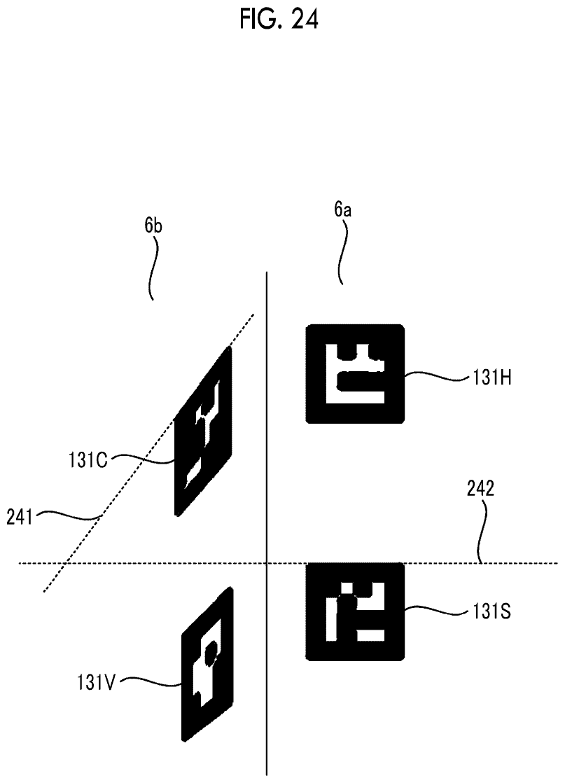

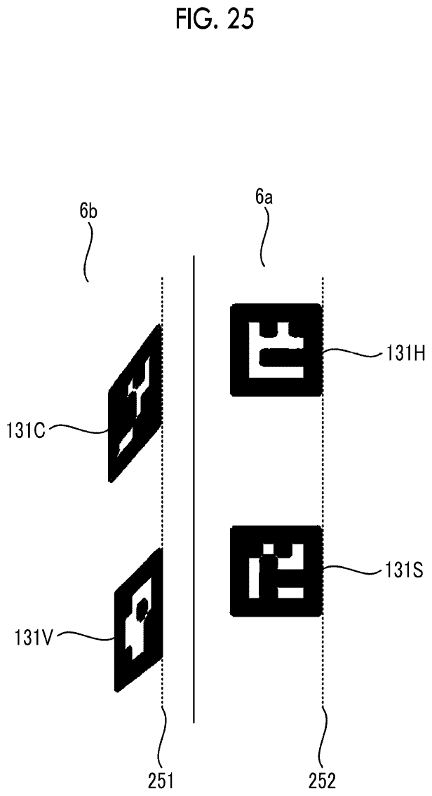

FIGS. 24 and 25 are diagrams showing specific examples of the determination of whether or not the plurality of marker projection images are present on the same plane. A straight line 241 in FIG. 24 is a straight line connecting an upper left end and an upper right end of the C marker projection image 131C in the imaging data obtained by the imaging device 30. A straight line 242 in FIG. 24 is a straight line connecting an upper left end and an upper right end of the S marker projection image 131S in the imaging data obtained by the imaging device 30. A straight line 251 in FIG. 25 is a straight line connecting the upper right end and a lower right end of the C marker projection image 131C in the imaging data obtained by the imaging device 30. A straight line 252 in FIG. 25 is a straight line connecting the upper right end and a lower right end of the S marker projection image 131S in the imaging data obtained by the imaging device 30.

The computer 50 calculates the straight line 241 based on the detection result of the C marker projection image 131C via the marker detection processing, and calculates the straight line 242 based on the detection result of the S marker projection image 131S via the marker detection processing. Then, the computer 50 calculates an angle between the straight line 241 and the straight line 242, and determines that the C marker projection image 131C and the S marker projection image 131S are not present on the same plane in a case where the calculated angle is equal to or greater than a predetermined value. In this case, for example, in the processing shown in FIG. 13, the computer 50 makes each determination assuming that the C marker 130C is not detected.

In addition, the computer 50 calculates the straight line 251 based on the detection result of the C marker projection image 131C via the marker detection processing, and calculates the straight line 252 based on the detection result of the S marker projection image 131S via the marker detection processing. Then, the computer 50 may calculate an angle between the straight line 251 and the straight line 252, and may determine that the C marker projection image 131C and the S marker projection image 131S are not present on the same plane in a case where the calculated angle is equal to or greater than a predetermined value. In this case, for example, in the processing shown in FIG. 13, the computer 50 makes each determination assuming that the C marker 130C is not detected.

A case where it is determined whether or not the C marker projection image 131C is present in the same plane as the S marker projection image 131S has been described, but the computer 50 also determines whether or not the H marker projection image 131H or the V marker projection image 131V is present in the same plane as the S marker projection image 131S in the same manner, and in the processing shown in FIG. 13, each determination is made that the marker image corresponding to the marker projection image determined not to be present in the same plane as the S marker projection image 131S is not detected.

As described above, the computer 50 may determine the continuity of the plurality of marker images based on a result obtained by determining, via the image processing, whether or not the marker images detected via the marker detection processing among the plurality of the marker images are projected on the same plane. As a result, for example, even in a state in which some marker images pass through the boundary between the planes and are not across the boundary between the planes, the continuity of the plurality of marker images can be correctly determined via the projectable range specifying processing 71.

<Setting of Content Projection Range with Respect to Auxiliary Line>

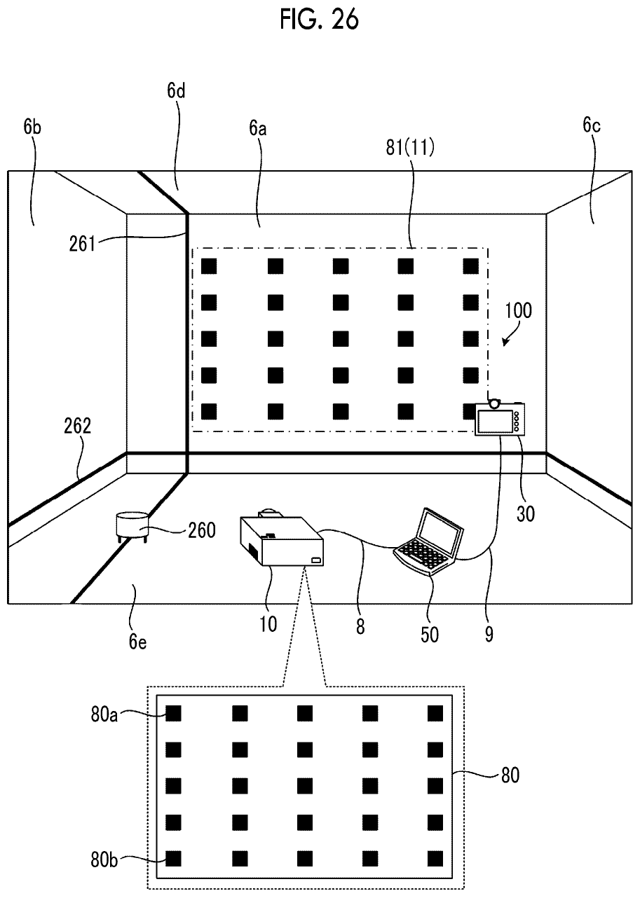

FIGS. 26 to 29 are diagrams showing examples of setting of the content projection range with respect to an auxiliary line. The adjustment of matching the end parts of the content projection ranges 80c and 130c with the end part of the wall 6a, that is, the end part of the physical plane has been described, but the adjustment of the content projection ranges 80c and 130c is not limited to this.

For example, a laser-marking device 260 shown in FIG. 26 is a device that irradiates the wall 6a, the wall 6b, the wall 6c, the ceiling 6d, and the floor 6e with laser light to display a reference line such as “horizontal” and “vertical”. A reference line 261 is a reference line displayed on the wall 6a, the ceiling 6d, and the floor 6e via the irradiation with the laser light from the laser-marking device 260. A reference line 262 is a reference line displayed on the wall 6a, the wall 6b, and the wall 6c via the irradiation with the laser light from the laser-marking device 260.

The computer 50 can also perform adjustment of matching the end parts of the content projection ranges 80c and 130c to the reference line 261 or the reference line 262. For example, colors of the marker images of the marker grid images 80 and 130 projected from the projection apparatus 10 is set to the same color as or a similar color to a color of the reference line 261 or the reference line 262.

As a result, it is difficult to detect the marker image that overlaps the reference line 261 or the reference line 262 among the marker images of the marker grid images 80 and 130 in the marker detection processing. Therefore, the adjustment of matching the end parts of the content projection ranges 80c and 130c with the reference line 261 or the reference line 262 can be performed via the processing shown in FIGS. 7 and 14.

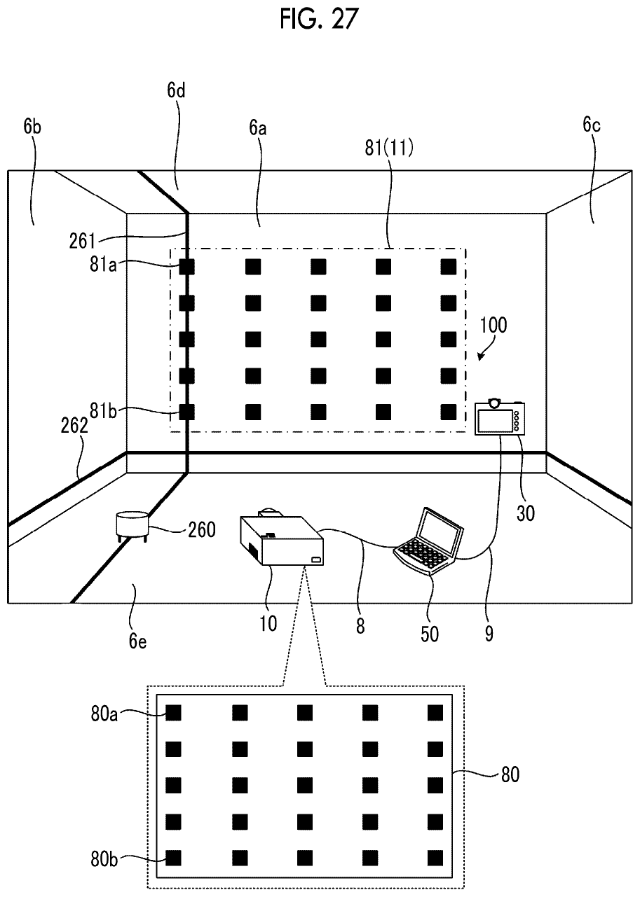

Here, a case where the left end of the content projection range 80c is matched with a right end of the reference line 261 will be described. In a case where the projectable range specifying processing 71 shown in FIG. 7 is executed in a state of FIG. 26, that is, in a case where the projectable range 11 is shifted to the left via the optical system shifting, the computer 50 fails in the marker detection at a timing at which the projection images of the marker images at the left end among the marker images of the marker grid image 80 overlap the reference line 261, and a state shown in FIG. 27 is obtained.

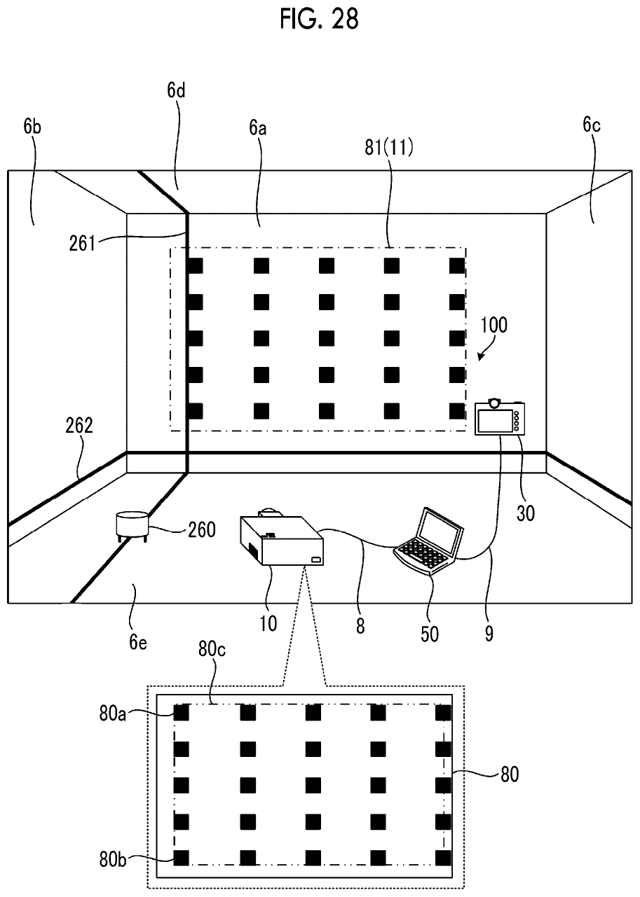

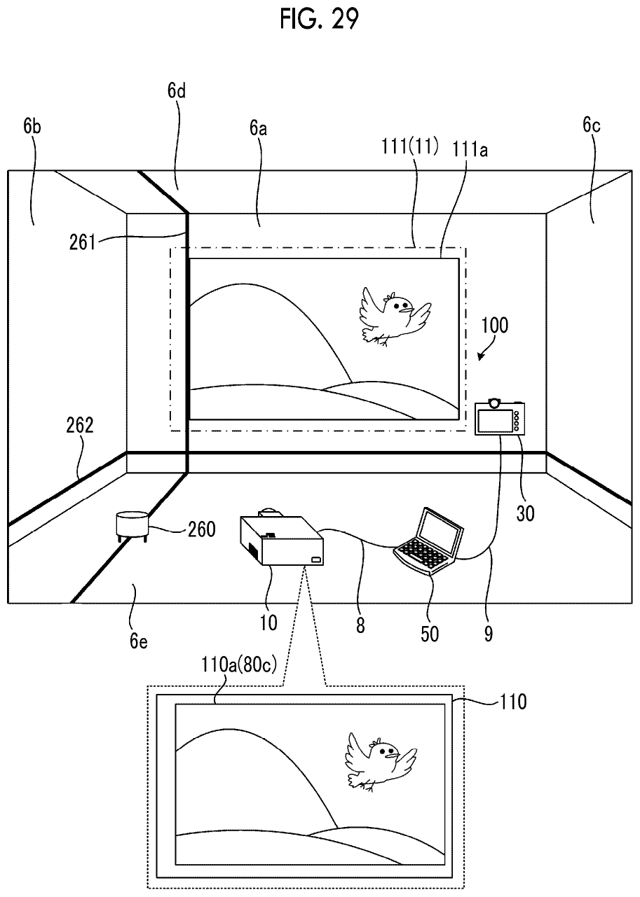

Next, in a case where the content projection range specifying processing 72 shown in FIG. 7 is executed from the state of FIG. 27, that is, in a case where each marker image of the marker grid image 80 is shifted to the right by the electronic shifting, the computer 50 succeeds in the marker detection at a timing at which the projection images of the marker images at the left end among the marker images of the marker grid image 80 do not overlap the reference line 261, and a state shown in FIG. 28 is obtained. Also in this case, the computer 50 sets the content projection range 80c as in the example of FIG. 11. Then, the computer 50 performs control of causing the projection apparatus 10 to project the projection image 110 in which the content image 110a is disposed onto the content projection range 80c. As a result, a state shown in FIG. 29 is obtained.

As described above, the computer 50 can perform the adjustment of matching the end parts of the content projection ranges 80c and 130c with an end part other than the end part of the physical plane. Here, the adjustment of matching the end parts of the content projection ranges 80c and 130c with the end parts of the reference line 261 or the reference line 262 displayed by the laser-marking device 260 has been described, but instead of the reference line 261 or the reference line 262 displayed by the laser-marking device 260, for example, adjustment of matching the end parts of the content projection ranges 80c and 130c with to an end parts of a line tape can also be performed by attaching the line tape of the same color as or a similar color to the marker images to the wall 6a.

### Modification Example 1

While the configuration in which the optical axis K is not bent has been described as the configuration of the projection apparatus 10 in FIGS. 4 and 5, a configuration in which the optical axis K is bent once or more by providing a reflective member in the optical unit 106 may be adopted.

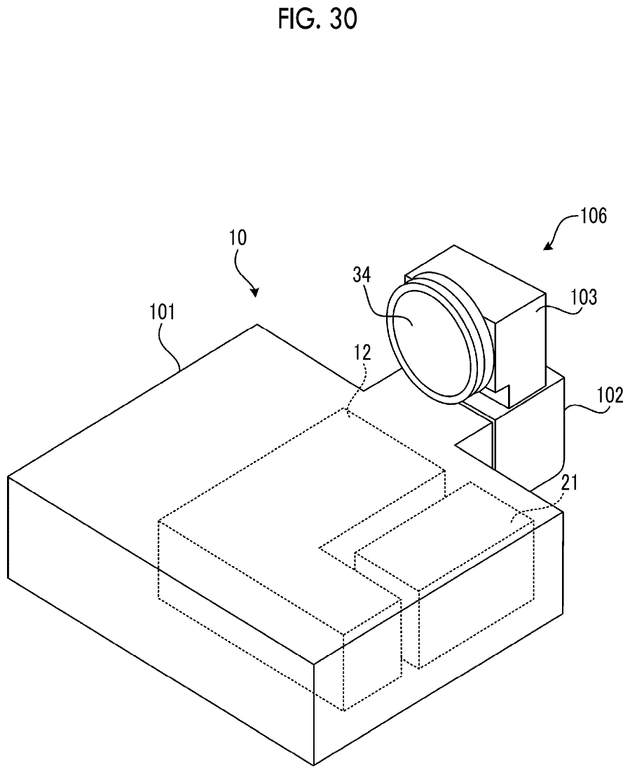

FIG. 30 is a schematic diagram showing another exterior configuration of the projection apparatus 10. FIG. 31 is a schematic cross-sectional view of the optical unit 106 of the projection apparatus 10 shown in FIG. 30. In FIGS. 30 and 31, the same parts as the parts shown in FIGS. 4 and 5 will be designated by the same reference numerals and will not be described.

As shown in FIG. 30, the optical unit 106 comprises a second member 103 supported by the first member 102 in addition to the first member 102 supported by the body part 101. The first member 102 and the second member 103 may be an integrated member.

As shown in FIG. 31, the optical unit 106 comprises, in addition to the first member 102, the second member 103 including a hollow portion 3A connected to the hollow portion 2A of the first member 102; the first optical system 121 and a reflective member 122 disposed in the hollow portion 2A; a second optical system 31, a reflective member 32, a third optical system 33, and the lens 34 disposed in the hollow portion 3A; the first shift mechanism 105; and a projection direction changing mechanism 104.

In the examples in FIGS. 30 and 31, the opening 2a and the opening 2b of the first member 102 are formed in surfaces perpendicular to each other. In addition, the optical projection system 23 shown in FIGS. 30 and 31 is composed of the reflective member 122, the second optical system 31, the reflective member 32, and the third optical system 33 in addition to the first optical system 121 and the lens 34 shown in FIGS. 4 and 5. With such an optical projection system 23, as shown in FIG. 31, the optical axis K is bent twice to be folded. The first optical system 121, the reflective member 122, the second optical system 31, the reflective member 32, the third optical system 33, and the lens 34 are disposed in this order from an optical modulation portion 22 side along the optical axis K.

The first optical system 121 guides the light that is incident on the first member 102 from the body part 101 and that travels in the direction X1 to the reflective member 122. The reflective member 122 reflects the light incident from the first optical system 121 in the direction Y1. The reflective member 122 is composed of, for example, a mirror. In the first member 102, the opening 2b is formed on an optical path of the light reflected by the reflective member 122, and the reflected light travels to the hollow portion 3A of the second member 103 by passing through the opening 2b.

The second member 103 is a member having an approximately L-shaped cross-sectional exterior, in which an opening 3a is formed at a position facing the opening 2b of the first member 102. The light from the body part 101 that has passed through the opening 2b of the first member 102 is incident into the hollow portion 3A of the second member 103 through the opening 3a. The first member 102 and the second member 103 may have any cross-sectional exterior and are not limited to the above.

The second optical system 31 includes at least one lens and guides the light incident from the first member 102 to the reflective member 32. The reflective member 32 guides the light incident from the second optical system 31 to the third optical system 33 by reflecting the light in the direction X2. The reflective member 32 is composed of, for example, a mirror. The third optical system 33 includes at least one lens and guides the light reflected by the reflective member 32 to the lens 34.

The lens 34 closes an opening 3c formed in an end part of the second member 103 on a direction X2 side and is disposed in the end part. The lens 34 projects the light incident from the third optical system 33 to the projection target object 6.

FIG. 31 shows the state where the first member 102 is moved as far as possible to the direction Y1 side by the first shift mechanism 105. By moving the first member 102 in the direction Y2 via the first shift mechanism 105 from the state shown in FIG. 31, the relative position between a center of the image formed by the optical modulation portion 22 and the optical axis K changes, and the image G1 projected to the projection target object 6 can be shifted in the direction Y1.

The projection direction changing mechanism 104 is a rotation mechanism that rotatably connects the second member 103 to the first member 102. By the projection direction changing mechanism 104, the second member 103 is configured to be rotatable about a rotation axis (specifically, the optical axis K) that extends in the direction Y. The projection direction changing mechanism 104 is not limited to a disposition position shown in FIG. 31 as long as the projection direction changing mechanism 104 can rotate the optical system. In addition, the number of rotation mechanisms is not limited to one, and a plurality of rotation mechanisms may be provided.

### Modification Example 2

While the computer 50 has been described as an example of the control device according to the embodiment of the present invention, the control device according to the embodiment of the present invention is not limited thereto. For example, the control device according to the embodiment of the present invention may be the projection apparatus 10. In this case, each control of the computer 50 is performed by the projection apparatus 10. The projection apparatus 10 may perform communication with the imaging device 30 via the computer 50, or may perform communication with the imaging device 30 without using the computer 50. A configuration in which the computer 50 is omitted from the projection system 100 may be adopted in a case where the projection apparatus 10 performs communication with the imaging device 30 without using the computer 50.

Alternatively, the control device according to the embodiment of the present invention may be the imaging device 30. In this case, each control of the computer 50 is performed by the imaging device 30. The imaging device 30 may perform communication with the projection apparatus 10 via the computer 50, or may perform communication with the projection apparatus 10 without using the computer 50. A configuration in which the computer 50 is omitted from the projection system 100 may be adopted in a case where the imaging device 30 performs communication with projection apparatus 10 without using the computer 50.

### Modification Example 3

While a case where the imaging in the projectable range specifying processing 71 and the imaging in the content projection range specifying processing 72 are performed by one imaging device 30 has been described, the imaging may be performed by different imaging device. However, in this case, it is desirable that each imaging device has the same or similar imaging characteristic.

### Modification Example 4

Although a case where the imaging device 30 is held by hand has been described, the imaging device 30 may be installed on the floor 6e, may be installed on a tripod, a pedestal, or the like installed on the floor 6e, or may be installed on the walls 6b and 6c, or the ceiling 6d by using an attachment tool.

### Modification Example 5

In the content projection range specifying processing 72 (second control), the control of moving or shifting all the marker images included in the marker grid images 80 and 130 has been described, but the present disclosure is not limited to such control. For example, in the content projection range specifying processing 72 (second control), the computer 50 may perform control of moving or shifting only some marker images among the marker images included in the marker grid images 80 and 130.

### <Control Program>

The control method described in the above embodiment can be realized by executing a control program prepared in advance by a computer. The present control program is executed by being recorded in a computer-readable storage medium and being read out from the storage medium. In addition, the present control program may be provided in a form of being stored in a non-transitory storage medium, such as a flash memory, or may be provided via a network, such as the Internet. The computer that executes the present control program may be included in the control device, may be included in an electronic apparatus such as a smartphone, a tablet terminal, or a personal computer that can communicate with the control device, or may be included in a server device that can communicate with the control device and the electronic apparatus.

At least the following items are disclosed in the present specification.

(1)

A control device comprising a processor,
in which the processor is configured to:
   determine, based on imaging data of a projection image of a first image projected by a projection apparatus, continuity of the projection image of the first image;
   perform first control of moving a boundary of a projection range of the projection apparatus in a first direction to the first direction at least until it is determined that the continuity is not present; and
   perform second control of moving a boundary of a projection range of the first image in the first direction to a second direction opposite to the first direction via image processing at least until it is determined that the continuity is present, after the first control.

(2)

The control device according to (1),
in which the processor is configured to perform control of causing the projection apparatus to project a content image onto a range based on the projection range of the first image in which it is determined that the continuity is present in the second control.

(3)

The control device according to (1) or (2),
in which the first control is at least any one of shifting or enlarging the projection range of the projection apparatus.

(4)

The control device according to any one of (1) to (3),
in which the second control is at least any one of shifting or reducing the projection range of the first image via the image processing.

(5)

The control device according to any one of (1) to (4),
in which the processor is configured to perform the first control by controlling an optical system of the projection apparatus.

(6)

The control device according to any one of (1) to (5),
in which the first image includes a plurality of marker images two-dimensionally arranged, and
the processor is configured to determine the continuity via detection processing of the plurality of marker images.

(7)

The control device according to (6),
in which the processor is configured to move, in the second control, boundaries of some marker images among the plurality of marker images in the first direction to the second direction.

(8)

The control device according to (6) or (7),
in which the processor is configured to perform, in the second control, processing of adding a marker image to the first image in a case where none of the plurality of marker images is detected.

(9)

The control device according to any one of (6) to (8),
in which the processor is configured to determine the continuity based on a result obtained by determining, via the image processing, whether or not marker images detected via the detection processing among the plurality of marker images are projected on a same plane.

(10)

The control device according to any one of (1) to (9),
in which the processor is configured to perform the first control and the second control by using a plurality of directions different from each other as the first direction.

(11)

The control device according to (10),
in which the first image includes a plurality of marker images two-dimensionally arranged and different from each other, and
the processor is configured to perform the second control for the plurality of directions based on detection processing of the plurality of marker images.

(12)

A control device comprising a processor,
in which the processor is configured to:
   perform, based on imaging data of a projection image of a plurality of marker images projected by a projection apparatus and two-dimensionally arranged, detection of the plurality of marker images;
   perform first control of moving a boundary of a projection range of the projection apparatus in a first direction to the first direction at least until some of the plurality of marker images are not detected; and
   perform second control of moving a projection range of the plurality of marker images to a second direction opposite to the first direction via image processing at least until the plurality of marker images are detected, after the first control.

(13)

A control method executed by a processor included in a control device, the control method comprising:
determining, based on imaging data of a projection image of a first image projected by a projection apparatus, continuity of the projection image of the first image;
performing first control of moving a boundary of a projection range of the projection apparatus in a first direction to the first direction at least until it is determined that the continuity is not present; and
performing second control of moving a projection range of the first image to a second direction opposite to the first direction via image processing at least until it is determined that the continuity is present, after the first control.

(14)

A control method executed by a processor included in a control device, the control method comprising:
performing, based on imaging data of a projection image of a plurality of marker images projected by a projection apparatus and two-dimensionally arranged, detection of the plurality of marker images;
performing first control of moving a boundary of a projection range of the projection apparatus in a first direction to the first direction at least until some of the plurality of marker images are not detected; and
performing second control of moving a projection range of the plurality of marker images to a second direction opposite to the first direction via image processing at least until the plurality of marker images are detected, after the first control.

(15)

A control program for causing a processor included in a control device to execute a process comprising:
determining, based on imaging data of a projection image of a first image projected by a projection apparatus, continuity of the projection image of the first image;
performing first control of moving a boundary of a projection range of the projection apparatus in a first direction to the first direction at least until it is determined that the continuity is not present; and
performing second control of moving a projection range of the first image to a second direction opposite to the first direction via image processing at least until it is determined that the continuity is present, after the first control.

(16)

A control program for causing a processor included in a control device to execute a process comprising:
performing, based on imaging data of a projection image of a plurality of marker images projected by a projection apparatus and two-dimensionally arranged, detection of the plurality of marker images;
performing first control of moving a boundary of a projection range of the projection apparatus in a first direction to the first direction at least until some of the plurality of marker images are not detected; and
performing second control of moving a projection range of the plurality of marker images to a second direction opposite to the first direction via image processing at least until the plurality of marker images are detected, after the first control.

While various embodiments have been described above, the present invention is, of course, not limited to such examples. It is apparent that those skilled in the art may perceive various modification examples or correction examples within the scope disclosed in the claims, and those examples are also understood as falling within the technical scope of the present invention. In addition, each constituent in the embodiment may be used in any combination without departing from the gist of the invention.

The present application is based on Japanese Patent Application (JP2022-030305) filed on Feb. 28, 2022, the content of which is incorporated in the present application by reference.

### EXPLANATION OF REFERENCES

1: projection portion
2: operation reception portion
2A, 3A: hollow portion
2a, 2b, 3a, 3c, 15a: opening
4: control portion
4a: storage medium
5: communication portion
6: projection target object
6a, 6b, 6c: wall
6d: ceiling
6e: floor
8, 9: communication cable
10: projection apparatus
11: projectable range
12: optical modulation unit
15: housing
21: light source
22: optical modulation portion
23: optical projection system
24: control circuit
30: imaging device
31: second optical system
32, 122: reflective member
33: third optical system
34: lens
50: computer
51: processor
52: memory
53: communication interface
54: user interface
59: bus
71: projectable range specifying processing
72: content projection range specifying processing
80, 130: marker grid image
80a, 80b, 80d to 81h: marker image
80c, 130c: content projection range
81, 131: marker grid projection image
81a, 81b, 81d to 81h: marker projection image
100: projection system
101: body part
102: first member
103: second member
104: projection direction changing mechanism
105: first shift mechanism
106: optical unit
110: projection image
110a: content image
111: projection image
111a: content projection image
121: first optical system
130C: C marker
130H: H marker
130S: S marker
130V: V marker
131C: C marker projection image
131H: H marker projection image
131S: S marker projection image
131V: V marker projection image
241, 242, 251, 252: straight line
260: laser-marking device
261, 262: reference line
G1: image

What is claimed is:

1. A control device comprising a processor,
wherein the processor is configured to:
determine, based on imaging data of a projection image of a first image projected by a projection apparatus, continuity of the projection image of the first image;
perform first control of moving a boundary, in a first direction, of a projection range of the projection apparatus to the first direction at least until the processor determines that the continuity is not present; and
perform second control of moving a boundary, in the first direction, of a projection range of the first image to a second direction opposite to the first direction via image processing at least until the processor determines that the continuity is present, after the first control.

2. The control device according to claim 1,
wherein the processor is configured to perform control of causing the projection apparatus to project a content image onto a range based on the projection range of the first image in which the processor determines that the continuity is present in the second control.

3. The control device according to claim 1,
wherein the first control is at least one of shifting or enlarging the projection range of the projection apparatus.

4. The control device according to claim 1,
wherein the second control is at least one of shifting or reducing the projection range of the first image via the image processing.

5. The control device according to claim 1,
wherein the processor is configured to perform the first control by controlling an optical system of the projection apparatus.

6. The control device according to claim 1,
wherein the first image includes a plurality of marker images two-dimensionally arranged, and
the processor is configured to determine the continuity via detection processing of the plurality of marker images.

7. The control device according to claim 6,
wherein the processor is configured to move, in the second control, boundaries, in the first direction, of part of the plurality of marker images to the second direction.

8. The control device according to claim 6,
wherein the processor is configured to perform, in the second control, processing of adding a marker image to the first image in a case where none of the plurality of marker images is detected.

9. The control device according to claim 6,
wherein the processor is configured to determine the continuity based on a result obtained by determining, via the image processing, whether or not marker images detected via the detection processing among the plurality of marker images are projected on a same plane.

10. The control device according to claim 1,
wherein the processor is configured to perform the first control and the second control by using a plurality of directions different from each other as the first direction.

11. The control device according to claim 10,
wherein the first image includes a plurality of marker images two-dimensionally arranged and different from each other, and
the processor is configured to perform the second control for the plurality of directions based on detection processing of the plurality of marker images.

12. A control device comprising a processor,
wherein the processor is configured to:
perform, based on imaging data of a projection image of a plurality of marker images projected by a projection apparatus and two-dimensionally arranged, detection of the plurality of marker images;
perform first control of moving a boundary, in a first direction, of a projection range of the projection apparatus to the first direction at least until part of the plurality of marker images are not detected; and
perform second control of moving a projection range of the plurality of marker images to a second direction opposite to the first direction via image processing at least until the plurality of marker images are detected, after the first control.

13. A control method executed by a processor included in a control device, the control method comprising:
determining, based on imaging data of a projection image of a first image projected by a projection apparatus, continuity of the projection image of the first image;
performing first control of moving a boundary, in a first direction, of a projection range of the projection apparatus to the first direction at least until the processor determines that the continuity is not present; and
performing second control of moving a projection range of the first image to a second direction opposite to the first direction via image processing at least until the processor determines that the continuity is present, after the first control.

14. A control method executed by a processor included in a control device, the control method comprising:
performing, based on imaging data of a projection image of a plurality of marker images projected by a projection apparatus and two-dimensionally arranged, detection of the plurality of marker images;
performing first control of moving a boundary, in a first direction, of a projection range of the projection apparatus to the first direction at least until part of the plurality of marker images are not detected; and
performing second control of moving a projection range of the plurality of marker images to a second direction opposite to the first direction via image processing at least until the plurality of marker images are detected, after the first control.
